(19) United States
(12) Patent Application Publication
(10) Pub. No.: US 2026/0145992 A1
(43) Pub. Date: May 28, 2026

(54) STRENGTHENED GLASS SUBSTRATES AND GLASS COMPOSITIONS THEREOF

(71) Applicant: CORNING INCORPORATED, CORNING, NY (US)

(72) Inventors: Jason Roy Grenier, Horseheads, NY (US); Konstantin Sergeevich Koreshkov, Espoo (FI); Lisa Ann Lamberson, Painted Post, NY (US); Peter Joseph Lezzi, Corning, NY (US); Robert Anthony Schaut, Horseheads, NY (US); Mariia Serova, Espoo (FI); Stanislav Sikulskyi, Corning, NY (US); Nicholas James Smith, Port Matilda, PA (US); Mark Owen Weller, Painted Post, NY (US)

(21) Appl. No.: 19/348,288

(22) Filed: Oct. 2, 2025

Related U.S. Application Data
(60) Provisional application No. 63/725,200, filed on Nov. 26, 2024.

(51) Int. Cl. C03C 3/093; C03C 3/091; C03C 3/11; C03C 21/00

(52) U.S. Cl. CPC C03C 3/093; C03C 3/091; C03C 3/11; C03C 21/002

(57) ABSTRACT

Provided is a glass substrate having low charging properties. The glass substrate is characterized by comprising, in terms of mass %, from 1.7% to less than 9% of B2O3, not more than 0.01% of Li2O, 0.001-0.03% of Na2O, 0.0001-0.007% of K2O, 0.0011-0.035% of Na2O+K2O and more than 0% to 0.4% of SnO2 as glass composition.

This application claims the benefit of priority to U.S. Provisional Patent Application Ser. No. 63/725,200 filed on Nov. 26, 2024, the content of which is relied upon and incorporated herein by reference in its entirety.

### FIELD

The disclosure relates to strengthened glass substrates with a modified surface region and glass compositions thereof.

### BACKGROUND

There is an increase in market demand for computing platforms, such as desktops, laptops, and smartphones, to have higher and higher performance levels. One way to increase the performance level of these platforms is to integrate more circuit devices into a single package on a chip. But, with such increased integration, performance features such as breakability, warpage, power delivery, and thermal management become even more important. Traditionally, organic interposer panels are integrated into chip assemblies due to their low cost and ease of manufacture. However, organic interposer panels exhibit poor performance features and disadvantageously have high thermal mismatch with other circuit materials, such as silicon, which in turn limits the output of the chip assembly. Thus, there is a need in the art for interposer panels in chip assemblies that can keep up with the ever increasing performance demands.

### SUMMARY

According to embodiments of the present, disclosure, a strengthened glass substrate for use as an interposer panel in a chip assembly in disclosed. The glass substrate may be strengthened with an ion-exchange process. Furthermore, the glass substrate may comprise an ion-exchangeable glass composition.

According to a first aspect a glass substrate is disclosed, the glass substrate comprising a plurality of through-glass vias extending through the glass substrate, adjacent through-glass vias being separated by a minimum average distance D_{M}. Furthermore, the glass substrate comprises a chemically strengthened region with a depth of layer such that the depth of layer extends from a surface of the glass substrate to a distance within a bulk of the glass substrate, the chemically strengthened region having a higher compressive stress than a remainder of the glass substrate, wherein the depth of layer of the chemically strengthened region is about 30% or less of the distance D_{M}.

According to a second aspect, a glass composition is disclosed, the glass composition comprising SiO₂ from about 67.0 mol % to about 85.0 mol %, Al₂O₃ from about 1.0 mol % to about 5.0 mol %, B₂O₃ from about 2.5 mol % to about 10.0 mol %, Na₂O from about 5.0 mol % to about 10.0 mol %, and K₂O from about 0.0 mol % to about 5.0 mol % wherein a ratio of monovalent metal oxides in mol % to divalent metal oxides in mol % in the glass composition is from about 1.0 to about 10.0, and wherein a ratio of a total concentration of the monovalent metal oxides in mol % and the divalent metal oxides in mol % to a concentration of Al₂O₃ in mol % in the glass composition is about 20.0 or less.

According to a third aspect, a method of forming a glass substrate with a chemically strengthened region, the method comprising immersing the glass substrate in a salt bath at a temperature from about 350° C. to about 525° C., wherein a composition of the glass substrate comprises the following components SiO₂ from about 67.0 mol % to about 85.0 mol %, Al₂O₃ from about 1.0 mol % to about 5.0 mol %, and B₂O₃ from about 2.5 mol % to about 10.0 mol %, a ratio of monovalent metal oxides in mol % to divalent metal oxides in mol % in the glass composition being from about 1.0 to about 10.0.

### BRIEF DESCRIPTION OF THE DRAWINGS

FIG. 1 shows a glass interposer panel with a plurality of through-glass vias formed therethrough, according to the embodiments disclosed herein;

FIG. 2 shows a process to form damage tracks and the through-glass vias in a glass substrate, according to the embodiments disclosed herein;

FIG. 3 shows a laser that produces the damage tracks in the substrate, according to the embodiments disclosed herein;

FIG. 4 shows a side view of a glass substrate with a plurality of chemically strengthened regions formed by an ion exchange process, according to the embodiments disclosed herein;

FIGS. 5A and 5B show various through-glass via configurations in glass substrates with a minimum distance between adjacent through-glass vias;

FIG. 6 is a plot of failure load vs. probability of failure for four glass substrates with through-glass vias formed therethrough;

FIG. 7A is a plot of a ratio of depth of layer to distance D_{M} vs. maximum out-of-plane deformation of glass substrates; and

FIG. 7B is a plot of a ratio of depth of layer to distance D_{M} vs. compressive stress ratio of two glass substrates that comprise portions with through-glass vias disposed therein and portions that do not comprise through-glass vias disposed therein.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms, such as up, down, right, left, front, back, top, bottom, above, below, and the like, are made only with reference to the figures as drawn and are not intended to imply absolute orientation.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

With reference to FIG. 1, a glass interposer panel 10 is shown as comprising a glass substrate 20 with a plurality of through-glass vias 30 formed therethrough. Glass substrate 20 comprises a silicate glass, as discussed further below. Furthermore glass substrate 20 is chemically strengthened to reduce the propensity of radial glass cracks in the glass. Through-glass vias 30 may comprise a plurality of patterns and configurations on glass substrate 20. In embodiments, glass interposer panel 10 may be separated into sub-panels along dividing lines 12. Glass interposer panel 10 may be used in a chip assembly, for example, as a glass core to provide metallization pathways within the chip assembly.

Glass substrate 20 may comprise a glass body upon which one or more additional layers or coatings may be applied. In embodiments, glass substrate 20 may be a substrate, a body, a glass, a wafer, and/or a block.

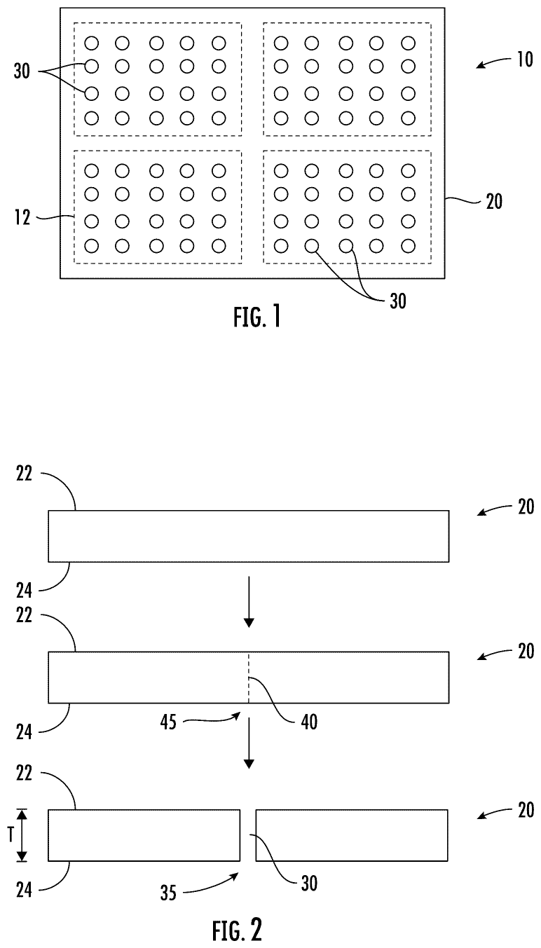

Formation of through-glass vias 30 in glass substrate 20 may comprise irradiating the substrate with a laser beam. As shown in FIG. 2, glass substrate 20 may comprise a first major surface 22 and a second major surface 24 such that irradiating the substrate forms a damage track 40 that extends from first major surface 22 to second major surface 24. As described herein, a “damage track” is an area of glass that has been structurally modified with a laser. In embodiments, damage track 40 may comprise a plurality of voids in the glass. In some embodiments, damage track 40 has a lower refractive index and/or a lower density than the surrounding undamaged glass.

Damage tracks 40 described herein may be formed by a variety of laser processes. FIG. 3 depicts an embodiment of a process to irradiate glass substrate 20 with a laser beam 100 to form damage track 40. In particular, laser beam 100 may be a pulsed laser beam that is focused into a laser beam focal line 110 that is positioned through the bulk of glass substrate 20. Laser beam focal line 110 may generate an induced multi-photon absorption within glass substrate 20. The multi-photon absorption produces a material modification within glass substrate 20 along laser beam focal line 110, forming damage track 40. Laser beam focal line 110 may be created by optics 120. In embodiments, optics 120 may include a conical lens, such as an axicon. Additional description of methods for generating and using a laser beam focal line for forming damage tracks is provided in U.S. Patent Application Publication No. 2021/0269357 and in U.S. Pat. No. 9,517,963, the entirety of each of which are incorporated by reference herein.

The optics 120 may from laser beam 100 into an extended focus, or quasi-non-diffracting beam resulting in a Bessel-like beam or a Gauss-Bessel beam. Because of the quasi-non-diffracting nature of the beam, the light may maintain a tight focused intensity over a much longer range than is achieved with more commonly used Gaussian beams, allowing the full thickness of glass-based substrate 20 to be damaged by a single burst pulse or a closely timed burst train of laser pulses. In one or more embodiments, the laser beam may be focused into a laser beam focal line extending at least from first major surface 22 of glass substrate 20 to second major surface 24 of glass substrate 20. In yet some embodiments, damage track 40 may be formed in glass substrate 20 using filamentration optics.

To modify glass substrate 20 and create damage track 40, the wavelength of the pulsed laser beam should be transparent to glass substrate 20. In one or more embodiments, the laser beam may have a wavelength from about 300 nm to about 2000 nm. For example, the laser beam may have a wavelength from about 300 nm to about 2000 nm, from about 500 nm to about 2000 nm, from about 700 nm to about 2000 nm, from about 900 nm to about 2000 nm, from about 1100 nm to about 2000 nm, from about 1300 nm to about 2000 nm, from about 1500 nm to about 2000 nm, from about 1700 nm to about 2000 nm, from about 1900 nm to about 2000 nm, from about 300 nm to about 1800 nm, from about 300 nm to about 1600 nm, from about 300 nm to about 1400 nm, from about 300 nm to about 1200 nm, from about 300 nm to about 1000 nm, from about 300 nm to about 800 nm, from about 300 nm to about 600 nm, from about 300 nm to about 400 nm, or any range or combination of ranges formed from these endpoints.

The pulse duration and intensity of the pulsed laser beam should be short enough to achieve the multi-photon absorption effect described above. Ultra-short pulse lasers may be utilized, such as picosecond or femtosecond laser sources. In one or more embodiments, the laser beam may be formed with a picosecond laser. The operation of such a picosecond laser described herein may create a “pulse burst” sub-pulses. Producing pulse bursts is a type of laser operation where the emission of pulses is not in a uniform and steady stream, but rather in tight clusters of sub-pulses. Each pulse burst contains multiple individual sub-pulses of very short duration. For example, each pulse burst may include at least 2 sub-pulses, at least 3 sub-pulses, at least 4 sub-pulses, or at least 5 sub-pulses of very short duration. A pulse burst is a pocket of sub-pulses and the pulse bursts are separated from one another by a longer duration than the separation of individual adjacent pulses within each burst. In one or more embodiments, sub-pulses may have a duration of up to 100 picoseconds. For example, sub-pulses may have a duration of about 0.1 picoseconds, about 5 picoseconds, about 10 picoseconds, about 15 picoseconds, about 18 picoseconds, about 20 picoseconds, about 22 picoseconds, about 25 picoseconds, about 30 picoseconds, about 50 picoseconds, about 75 picoseconds, about 100 picoseconds, or any range or combination of ranges formed from these endpoints. These individual sub-pulses within a single pulse burst are referred to as sub-pulses herein to denote the fact that they occur within a single pulse burst. The energy or intensity of each individual sub-pulse within the pulse burst may not be equal to that of other sub-pulses within the pulse burst, and the intensity distribution of the multiple sub-pulses within a pulse burst often follows an exponential decay in time governed by the laser design.

Each sub-pulse within the pulse burst of the exemplary embodiments described herein is separated in time from the subsequent sub-pulse in the burst by a duration tₚ, which is from about 1 nanosecond to about 50 nanoseconds (e.g. about 10-50 nanoseconds, or about 10-30 nanoseconds, with the time often governed by the laser cavity design). For a given laser, the time separation tₚ between each sub-pulses (sub-pulse-to-sub-pulse separation) within a pulse burst is relatively uniform (±10%). For example, in some embodiments, each sub-pulse within a pulse burst may be separated in time from the subsequent sub-pulse by about 20 nanoseconds (about 50 MHz). For example, for a laser that produces a sub-pulse separation tₚ of about 20 nanoseconds, the sub-pulse-to-sub-pulse separation tₚ within a pulse burst is maintained within about ±10%, or is about ±2 nanoseconds.

In one or more embodiments, damage track 40 may comprise a plurality of voids in the glass substrate 20. The plurality of voids may be arranged in a straight line normal to first major surface 22 and/or second major surface 22 of glass substrate 20. In embodiments, damage track 40 may have a diameter 45, as shown in FIG. 2, of about 2 microns or less, or about 1.75 microns or less, or about 1.5 microns or less, or about 1.0 micron or less, 0.75 microns or less, or about 0.5 microns or less, or any range encompassing these endpoints.

With reference again to FIG. 2, after formation of damage track 40, glass substrate 20 may be contacted with one or more etchants to from through-glass via 30. Without intending to be bound by theory, damage track 40 may be more susceptible to etching than the undamaged body of glass substrate 20. Accordingly, glass may be removed from damage track 40 at a greater rate than from undamaged portions of glass substrate 20. This allows through-glass via 30 to be formed in glass substrate 30 from damage track 40.

Glass substrate 20 may be contacted with the one or more etchants by any suitable means. For example, the one or more etchants may be sprayed onto glass substrate 20 or glass substrate 20 may be immersed in a bath of the etchant(s). Using a bath of the etchant(s) for contacting glass substrate 20 with the etchant(s) may allow for multiple glass substrates 20 to be etched in a parallel process, as multiple glass substrates 20 could be immersed in a single bath of the etchant(s) simultaneously.

In embodiments, the one or more etchants may comprise one or more bases such as, for example, one or more hydroxides. Exemplary hydroxides include, for example, potassium hydroxide, sodium hydroxide, calcium hydroxide, ammonium hydroxide, tetramethylammonium hydroxide, and/or lithium hydroxide. In yet other embodiments, the one or more etchants may comprise one or more fluoride compounds such as, for example, ammonium bifluoride, ammonium fluoride, sodium fluoride and/or fluorosilicic acid. In yet other embodiments, the one or more etchants may comprise one or more acids such as, for example, hydrofluoric acid, hydrochloric acid, nitric acid, and/or sulfuric acid. In some embodiments, an etchant may comprise from about 20 vol. % to about 75 vol. % of the one or more bases or acids, based on the volume of the etchant. For example, an etchant may comprise the one or more bases or acids, based on the volume of the etchant, from about 20 vol. % to about 75 vol. %, from about 30 vol. % to about 75 vol. %, from about 40 vol. % to about 75 vol. %, from about 50 vol. % to about 75 vol. %, from about 60 vol. % to about 75 vol. %, from about 70 vol. % to about 75 vol. %, from about 20 vol. % to about 65 vol. %, from about 20 vol. % to about 55 vol. %, from about 20 vol. % to about 45 vol. %, from about 20 vol. % to about 35 vol. %, from about 20 vol. % to about 25 vol. %, or any range or combination of ranges formed from these endpoints. Without intending to be bound by theory, increasing the concentration of the one or more bases or the one or more acids in the etchant may increase the rate at which the etchant etches glass substrate 20.

In yet some particular embodiments, the one or more etchants may comprise from about 10 vol. % to about 100 vol. % of an about 10 wt. % to about 80 wt. % of the acid and/or base. In yet some more particular embodiments, the one or more etchants may comprise from about 10 vol. % to about 50 vol. % of an about 10 wt. % to about 50 wt. % of the acid and/or base. For example, the one or more etchants may comprise about 10 vol. % of an about 10 wt. % to about 50 wt. % solution of hydrofluoric acid, hydrochloric acid, nitric acid, sodium hydroxide, or potassium hydroxide. As additional examples, the one or more etchants may comprise about 10 vol. % of an about 10 wt. % to about 30 wt. % solution of hydrofluoric acid, hydrochloric acid, nitric acid, sodium hydroxide, or potassium hydroxide.

It is also contemplated that the one or more etchants comprise from about 1 wt. % to about 80 wt. %, or about 1 wt. % to about 70 wt. %, or about 1 wt. % to about 60 wt. %, or about 1 wt. % to about 50 wt. %, or about 1 wt. % to about 40 wt. %, or about 1 wt. % to about 30 wt. %, or about 1 wt. % to about 20 wt. %, or about 1 wt. % to about 10 wt. %, or any combination of these ranges, of the total acids or bases based on the concentration of the etchant.

In embodiments, glass substrate 20 may be contacted with the one or more etchants at a temperature from about 0° C. to about 200° C. For example, glass substrate 20 may be contacted with the one or more etchants at a temperature from about 10° C. to about 200° C., or about 20° C. to about 180° C., or about 30° C. to about 160° C., or about 40° C. to about 150° C., or about 50° C. to about 140° C., or about 60° C. to about 120° C., or about 70° C. to about 110° C., or about 80° C. to about 100° C., or about 90° C. to about 100° C., or about 25° C. to about 100° C., or about 25° C. to about 75° C., or any range or combination of ranges formed from these endpoints. Without intending to be bound by theory, the temperature at which glass substrate 20 is contacted with the one or more etchants may affect the rate at which glass substrate 20 is etched. For example, increasing the temperature may increase the rate at which glass substrate 20 is etched.

In one or more embodiments, glass substrate 20 may be contacted with the one or more etchants for a time from about 30 minutes to about 72 hours. For example, glass substrate 20 may be contacted with the one or more etchants for a time from about 30 minutes to about 72 hours, from about 1 hour to about 50 hours, from about 2 hours to about 30 hours, from about 5 hours to about 26 hours, from about 8 hours to about 24 hours, from about 10 hours to about 22 hours, from about 12 hours to about 20 hours, from about 14 hours to about 18 hours, from about 16 hours to about 18 hours, or any range or combination of ranges formed from these endpoints. Without intending to be bound by theory, increasing the time over which glass substrate 20 is contacted with the one or more etchants may increase the amount of material that is etched from glass substrate 20. Increasing the time over which glass substrate 20 is contacted with the one or more etchants may increase a diameter of through-glass via 30.

In one or more embodiments, an etch rate of glass substrate 20 at damage track 40 when contacted with the one or more etchants may be from about 0.35 μm/hr or greater, or about 0.50 μm/hr or greater, or about 0.75 μm/hr or greater, or about 1.00 μm/hr or greater, or about 1.25 μm/hr or greater, or about 1.50 μm/hr or greater, or about 1.75 μm/hr or greater, or about 2.00 μm/hr or greater, or about 2.25 μm/hr or greater, or about 2.50 μm/hr or greater, or about 2.75 μm/hr or greater, or about 3.00 μm/hr or greater, or about 3.25 μm/hr or greater, or about 3.50 μm/hr or greater, or about 3.75 μm/hr or greater, or about 4.00 μm/hr or greater, or about 4.25 μm/hr or greater, or about 4.50 μm/hr or greater, or about 4.75 μm/hr or greater, or about 5.00 μm/hr or greater, or about 5.25 μm/hr or greater, or about 5.50 μm/hr or greater, or about 5.75 μm/hr or greater, or about 6.00 μm/hr or greater, or about 10.00 μm/hr or greater, or about 15.00 μm/hr or greater, or about 20.00 μm/hr or greater, or about 25.00 μm/hr or greater, or about 30.00 μm/hr or greater, or about 35.00 μm/hr or greater, or about 40.00 μm/hr or greater, or about 45.00 μm/hr or greater, or about 50.00 μm/hr or greater, or about 55.00 μm/hr or greater, or about 60.00 μm/hr or greater or about 70.00 μm/hr or greater, or about 80.00 μm/hr or greater, or about 90.00 μm/hr or greater, or about 100.00 μm/hr or greater, or about 110.00 μm/hr or greater, or about 120.00 μm/hr or greater. Additionally or alternatively, an etch rate of the damage track 120 contacted with the second etchant may be about 120.00 μm/hr or less, or about 110.00 μm/hr or less, or about 100.00 μm/hr or less, or about 90.00 μm/hr or less, or about 80.00 μm/hr or less, or about 70.00 μm/hr or less, or about 60.00 μm/hr or less, or about 55.00 μm/hr or less, or about 50.00 μm/hr or less, or about 45.00 μm/hr or less, or about 40.00 μm/hr or less, or about 35.00 μm/hr or less, or about 30.00 μm/hr or less, or about 25.00 μm/hr or less, or about 20.00 μm/hr or less, or about 15.00 μm/hr or less, or about 10.00 μm/hr or less, or about 6.00 μm/hr or less, or about 5.75 μm/hr or less, or about 5.50 μm/hr or less, or about 5.25 μm/hr or less, or about 5.00 μm/hr or less, or about 4.75 μm/hr or less, or about 4.50 μm/hr or less, or about 4.25 μm/hr or less, or about 4.00 μm/hr or less, or about 3.75 μm/hr or less, or about 3.50 μm/hr or less, or about 3.25 μm/hr or less, or about 3.00 μm/hr or less, or about 2.75 μm/hr or less, or about 2.50 μm/hr or less, or about 2.25 μm/hr or less, or about 2.00 μm/hr or less, or about 1.75 μm/hr or less, or about 1.50 μm/hr or less, or about 1.25 μm/hr or less, or about 1.00 μm/hr or less, or about 0.75 μm/hr or less, or about 0.50 μm/hr or less, or about 0.35 μm/hr or less. In embodiments, the etch rate is from about 0.35 μm/hr to about 120.00 μm/hr, or about 0.50 μm/hr to about 110.00 μm/hr, or about 0.75 μm/hr to about 100.00, or about 1.00 μm/hr to about 90.00 μm/hr, or about 1.25 μm/hr to about 80.00 μm/hr, or about 1.50 μm/hr to about 70.00 μm/hr, or about 1.75 μm/hr to about 60.00 μm/hr, or about 2.00 μm/hr to about 55.00 μm/hr, or about 2.25 μm/hr to about 50.00 μm/hr, or about 2.50 μm/hr to about 45.00 μm/hr, or about 2.75 μm/hr to about 40.00 μm/hr, or about 3.00 μm/hr to about 35.00 μm/hr, or about 3.25 μm/hr to about 30.00 μm/hr, or about 3.50 μm/hr to about 25.00 μm/hr, or about 3.75 μm/hr to about 20.00 μm/hr, or about 4.00 μm/hr to about 15.00 μm/hr, or about 4.25 μm/hr to about 10.00 μm/hr, or about 4.75 μm/hr to about 6.00 μm/hr, or about 5.00 μm/hr to about 5.75 μm/hr, or about 5.25 μm/hr to about 5.50 μm/hr, or any range or combination of ranges formed from these endpoints.

As described herein, an “etch rate” may be determined by measuring the thickness of glass substrate 20 before it is contacted with an etchant, measuring the thickness of glass substrate 20 after it is contacted with the etchant, and dividing a difference in the thicknesses by the time over which glass substrate 20 was contacted with the etchant.

The formed through-glass via 30 may have a substantially cylindrical shape in cross-section. As described herein, a “substantially cylindrical shape” refers to a shape that deviates from a cylinder by less than about 10%, less than about 5%, less than about 3%, or even less than about 1% in any dimension. For example, a radius of a substantially cylindrical shape may deviate from the radius of a corresponding cylinder by less than about 10% in any radial direction at any height. However, in other embodiments, through-glass vias 30 may comprise other cross-sectional shapes such as, for example, pinched, hourglass, barbell, and/or beveled.

Furthermore, the formed through-glass via 30 may have a diameter 35, as shown in FIG. 2, of about 10 microns or greater. For example, through-glass via 30 may have a diameter of about 10 microns or greater, about 20 microns or greater, about 30 microns or greater, about 40 microns or greater, about 50 microns or greater, about 60 microns or greater, about 70 microns or greater, about 80 microns or greater, about 90 microns or greater, about 100 microns or greater, about 100 microns or greater, about 110 microns or greater, about 120 microns or greater, about 130 microns or greater, about 140 microns or greater, about 150 microns or greater, about 160 microns or greater, about 170 microns or greater, about 180 microns or greater, about 190 microns or greater, about 200 microns or greater, or any range or combination of ranges formed from these endpoints. In one or more embodiments, through-glass via 30 may have a diameter 35 from about 10 microns to about 200 microns. For example, through-glass via 30 may have a diameter from about 10 microns to about 200 microns, from about 30 microns to about 200 microns, from about 50 microns to about 200 microns, from about 70 microns to about 200 microns, from about 90 microns to about 200 microns, from about 110 microns to about 200 microns, from about 130 microns to about 200 microns, from about 150 microns to about 200 microns, from about 170 microns to about 200 microns, from about 190 microns to about 200 microns, from about 10 microns to about 180 microns, from about 10 microns to about 160 microns, from about 10 microns to about 140 microns, from about 10 microns to about 120 microns, from about 10 microns to about 100 microns, from about 10 microns to about 80 microns, from about 10 microns to about 60 microns, from about 10 microns to about 40 microns, from about 10 microns to about 20 microns, or any range or combination of ranges formed from these endpoints.

In embodiments, glass substrate 20 may have an average thickness T from first major surface 22 to second major surface, as shown in FIG. 2, of about 0.01 mm or greater, about 0.03 mm or greater, about 0.05 mm or greater, about 0.1 mm or greater, about 0.5 mm or greater, about 0.75 mm or greater, about 1.0 mm or greater, or about 1.1 mm or greater, or about 1.25 mm or greater, about 1.5 mm or greater, about 2.0 mm or greater, about 2.5 mm or greater, about 3.0 mm or greater, about 3.5 mm or greater, about 4.0 mm or greater, about 4.5 mm or greater, about 5.0 mm or greater, or any range or combination of ranges formed from these endpoints. For example, in some embodiments, the substrate thickness is from about 0.1 mm to about 1.1 mm.

Through-glass vias 30 may have an aspect ratio of about 5:1 or greater, about 10:1 or greater, about 15:1 or greater, about 20:1 or greater, about 25:1 or greater, about 30:1 or greater, about 35:1 or greater, about 40:1 or greater, about 45:1 or greater, or about 50:1. In embodiments, the aspect ratio is in a range from about 5:1 to about 50:1, or about 10:1 to about 45:1, or about 10:1 to about 40:1, or about 15:1 to about 35:1, or about 20:1 to about 30:1, or about 20:1 to about 25:1, or any range or combination of ranges formed from these endpoints. As used herein, the term “aspect ratio” refers to the ratio of the average thickness T of glass substrate 20 to the average diameter 35 of through-glass vias 30.

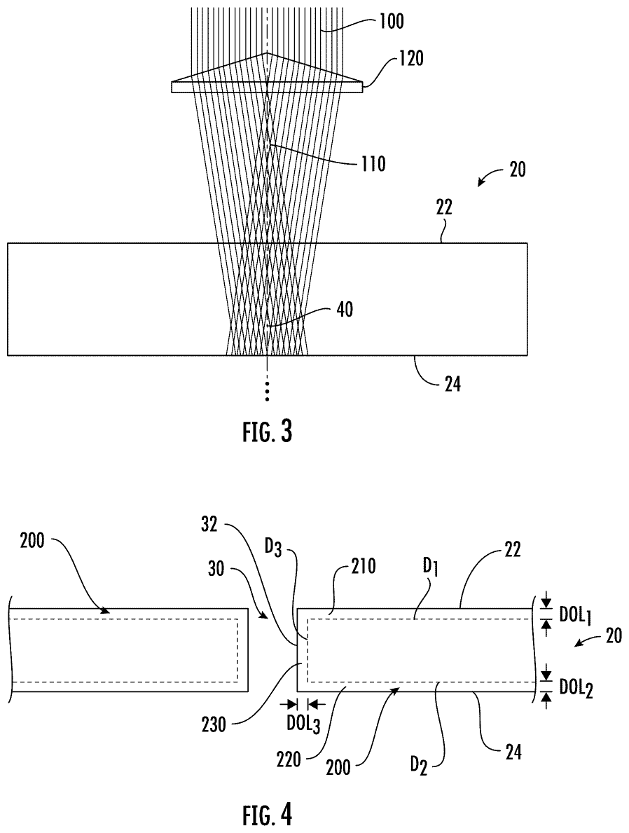

In embodiments, glass substrate 20 is chemically strengthened by, for example, an ion exchange process. As discussed further below, such an ion exchange process produces chemically strengthened regions 200 in glass substrate 20. More specifically, during the ion exchange process, glass substrate 20 is chemically strengthened by which smaller metal ions in the glass are replaced or “exchanged” with larger metal ions of the same valence within a layer of the glass that is close to an outer surface of the glass. The replacement of the smaller metal ions with the larger metal ions creates a compressive stress within the outer surface regions of the glass, thus producing chemically strengthened regions 200, as shown in FIG. 4.

The ion exchange processes, as disclosed herein, may be performed either before or after damage track 40 is exposed to the one or more etchants. Thus, the ion exchange processes disclosed herein may be performed either before or after the formation of through-glass vias 30. In some embodiments, the ion exchange process is performed after the formation of through-glass vias 30.

In embodiments of the ion exchange processes disclosed herein, the smaller metal ions are monovalent alkali metal ions, such as, for example, sodium (Na⁺), potassium (K⁺), or rubidium (Rb⁺) and these smaller monovalent alkali metal ions in glass substrate 20 are exchanged with a larger metal ion of a molten salt, such as, for example, potassium nitrate (KNO₃), potassium sulfate (K₂SO₄), or potassium chloride (KCl). In yet some other embodiments, smaller monovalent cations, such as, for example, silver (Ag⁺), Thallium (Tl⁺), or copper (Cu⁺) in glass substrate 20 are exchanged for the alkali metal cations. In some embodiments, glass substrate 20 is immersed in a bath of the molten salt to exchange the smaller metal ions for the larger metal ions.

During the ion exchange process, glass substrate 20 may be immersed in the salt bath for a duration from about 5 minutes to about 40 hours, or about 10 minutes to about 35 hours, or about 20 minutes to about 30 hours, or about 30 minutes to about 25 hours, or about 45 minutes to about 20 hours, or about 1 hour to about 15 hours, or about 2 hours to about 10 hours, or about 5 hours to about 7 hours, or any range encompassing these endpoints. The salt bath may be at a temperature from about 350° C. to about 525° C., or about 375° C. to about 500° C., or about 400° C. to about 475° C., or about 410° C. to about 450° C., or about 425° C. to about 430° C., or any range encompassing these endpoints.

In embodiments, the salt bath comprises an alkali metal. Furthermore, in embodiments, the relatively smaller alkali metal ions (e.g., sodium (Na⁺), potassium (K⁺), or rubidium (Rb⁺)) of glass substrate 20 are exchanged with the relatively larger alkali metal ions in the salt bath, thus producing the chemically strengthened regions 200 in glass substrate 20. It is noted that the exchange of the relatively smaller alkali metal ions with the relatively larger alkali metal ions does not take place throughout the bulk of glass substrate 20. Instead, the exchange of the alkali metal ions only occurs where the chemically strengthened regions 200 are produced.

In one exemplary embodiment, glass substrate 20, with through-glass vias 30 formed therein, is immersed in a KNO₃ salt bath so that Na⁺ ions in the glass are exchanged with K-ions, thus forming chemically strengthened regions 200. In this embodiment, chemically strengthened regions 200 comprise a reduced concentration of Na and a higher concentration of K as compared with the remainder of glass substrate 20.

As shown in FIG. 4, chemically strengthened regions 200 may comprise a first chemically strengthened region 210, a second chemically strengthened region 220, and a third chemically strengthened region 230. First chemically strengthened region 210 extends from first major surface 22 of glass substrate 20 to a distance D₁ within glass substrate 20. Second chemically strengthened region 220 extends from second major surface 24 to a distance D₂ within glass substrate 20. And third chemically strengthened region 230 extends from an interior surface 32 of through-glass via 30 to a distance D₃ within glass substrate 20. Thus, first chemically strengthened region 210 extends into glass substrate 20 for a depth of layer DOL₁ that extends from first major surface 22 to distance D₁. Second chemically strengthened region 220 extends into glass substrate 20 for a depth of layer DOL₂ that extends from second major surface to distance D₂. And third chemically strengthened region 230 extends into glass substrate for a depth of layer DOL₃ that extends from interior surface 32 to distance D₃. As used herein, “depth of layer” refers to the depth of the chemically strengthened region within the bulk of glass substrate 20.

Due to the ion exchange processes disclosed herein, chemically strengthened region 200 (e.g., 210, 220, 230) may have a higher compressive stress than a remainder of glass substrate 20. In embodiments, chemically strengthened region 200 (e.g., 210, 220, 230) may have a surface compressive stress of about 200 MPa or greater, or about 300 MPa or greater, or about 400 MPa or greater, or about 500 MPa or greater, or about 600 MPa or greater, or about 700 MPa or greater, or about 800 MPa or greater, or about 900 MPa or greater, or about 1000 MPa or greater, or any range or combination of ranges formed from these endpoints. In embodiments, the surface compressive stress of chemically strengthened region 200 is in a range from about 200 MPa to about 1000 MPa, or about 300 MPa to about 900 MPa, or about 400 MPa to about 800 MPa, or about 500 MPa to about 700 MPa, or about 600 MPa to about 700 MPa. Surface compressive stress is measured with a surface stress meter (FSM) such as the FSM-6000, as manufactured by Orihara Industrial Co., Ltd. (Japan). Surface compressive stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. The values reported for surface compressive stress herein refer to the peak surface compressive stress, unless otherwise indicated. In the embodiments disclosed herein, the surface compressive stress is measured using the FSM for the portions of the glass substrate 20 that do not comprise through glass vias 30 and then interpolated, based on these measurements, for the surface compressive stress of the portions of glass substrate 20 that do comprise through-glass vias 30.

The depth of layers disclosed herein (e.g., DOL₁, DOL₂, DOL₃) refer to the depth at which the stress within the glass substrate 20 changes from compressive to tensile. Therefore, at each of distances D₁, D₂, and D₃, the stress within glass substrate 20 crosses from a compressive stress to a tensile stress and thus exhibits a stress value of zero.

The duration of the salt bath, as described above, may determine the depth of layer (DOL₁, DOL₂, DOL₃) of each chemically strengthened regions 210, 220, 230 such that a longer salt bath produces relatively larger depth of layers.

In embodiments, the depth of layer of each of first chemically strengthened region 210, second chemically strengthened region 220, and third chemically strengthened region 240 may be equal to each other (or substantially equal to each other) such that DOL₁=DOL₂=DOL₃. It is also contemplated in embodiments that one or more depth of layers DOL₁, DOL₂, DOL₃ may be different from one or more other depth of layers. For example, the depth of layer DOL₁ of first chemically strengthened region 210 may be equal to the depth of layer DOL₂ of second chemically strengthened region 220 but may diff from the depth of layer DOL₃ of third chemically strengthened region 230.

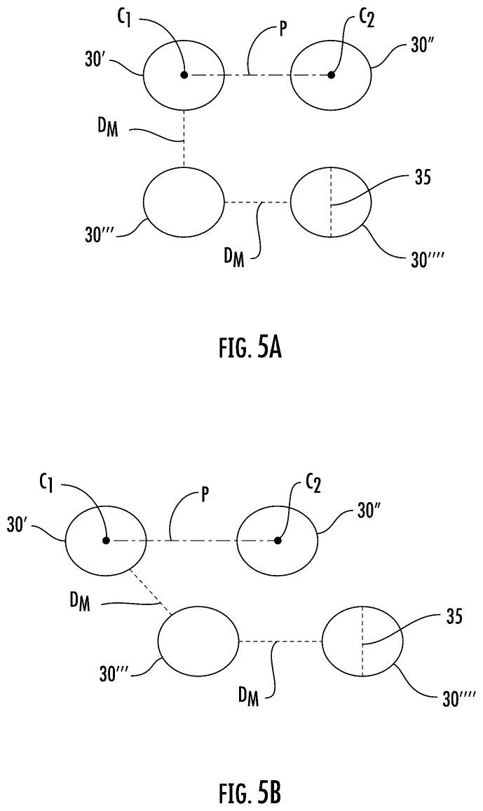

Furthermore, in embodiments, the depth of layer of each chemically strengthened region is based upon the average distance between adjacent through-glass vias 30. As shown in FIG. 5A, four exemplary through-glass vias 30′, 30″, 30′″, and 30″″ in a glass substrate 20 are shown in a square pattern. Adjacent through-glass vias 30 are separated by a distance D_{M}, such that D_{M} is the average minimum distance between two adjacent through-glass vias 30. FIG. 5A also shows the pitch P between adjacent through glass-vias 30, such that the pitch P is defined as the average minimum distance between a radially central point C₁ of a first through-glass via (e.g., through glass-via 30′) and a radially centrally point C₂ of a second through-glass via (e.g., through-glass 30″). Therefore, the minimum distance D_{M} can also be defined as the difference between the pitch P and the average diameter 35 of the through-glass vias 30.

It is noted that both the distance D_{M} and the pitch P are defined by the distance between the nearest adjacent through-glass vias 30. Thus, for example, the distance D_{M} and pitch P may be defined between adjacent through glass vias 30′ and 30″ or between adjacent through-glass vias 30′ and 30′″, as shown in FIG. 5A, as these coupled vias are nearest each other. However, the distance D_{M} and the pitch P are not defined by through-glass vias 30′ and 30″″, for example, as these vias are separated along the diagonal of the square pattern and, thus, have a relatively larger distance therebetween. In a glass substrate 20 with a variable pattern of through-glass vias 30, thus producing different pitch P values between the different through-glass vias 30, the distance D_{M} is the minimum distance between the through-glass vias 30.

FIG. 5B shows another embodiment of through-glass vias 30′, 30″, 30″′, and 30″″ in a glass substrate 20 but in which the through-glass vias 30 are arranged in an offset pattern. As shown in FIG. 5B, adjacent through-glass vias 30 are separated by the average minimum distance D_{M} and have an average pitch P. Similar to FIG. 5A above, both the distance D_{M} and the pitch P in the embodiment of FIG. 5B are defined by the distance between nearest adjacent through-glass vias 30. Thus, for example, the distance D_{M} and pitch P may be defined between adjacent through glass vias 30′ and 30″ or between adjacent through-glass vias 30′ and 30′″, as shown in FIG. 5B. However, the distance D_{M} and the pitch P are not defined by through-glass vias 30′ and 30″″, for example, as these vias are separated along the diagonal of the offset pattern and, thus, have a relatively larger distance therebetween.

As discussed above, the depth of layer of each chemically strengthened region 200 is based upon the average minimum distance D_{M} between adjacent through-glass vias 30. More specifically, the depth of layer (DOL₁, DOL₂, DOL₃) of each of first, second, and third chemically strengthened regions 210, 220, 230 is about 30% or less of the distance D_{M}. Therefore, in embodiments, at least one of Equations (1), (2), and (3) is satisfied:

$${DOL}_{1} \leq 0.3 \times {D}_{M} \qquad ( 1 )$$

$${DOL}_{2} \leq 0.3 \times {D}_{M} \qquad ( 2 )$$

$${DOL}_{3} \leq 0.3 \times {D}_{M} \qquad ( 3 )$$

In embodiments, each of Equations (1), (2) and (3) are satisfied. Furthermore, in yet some embodiments, the depth of layer (DOL₁, DOL₂, DOL₃) of at least one of first, second, and third chemically strengthened regions 210, 220, 230 is about 50% or less of the distance D_{M} so that at least one of Equations (4), (5), and (6) are satisfied:

$${DOL}_{1} \leq 0.5 \times {D}_{M} \qquad ( 4 )$$

$${DOL}_{2} \leq 0.5 \times {D}_{M} \qquad ( 5 )$$

$${DOL}_{3} \leq 0.5 \times {D}_{M} \qquad ( 6 )$$

As discussed further below, when at least one of Equations (1)-(6) are satisfied, maximum out-of-plane deformation of substrate 20 is reduced. In yet some embodiments, the first depth of layer DOL₁ of first chemically strengthened region 210, the second depth of layer DOL₂ of second chemically region 220, and/or the third depth of layer DOL₃ of third chemically strengthened region 230 is about 50.0% or less, or about 45.0% or less, or about 40.0% or less, or about 35.0% or less, or about 30.0% or less, or about 25.0% or less, or about 22.5% or less, or about 20% or less, or about 17.5% or less, or about 15% or less, or about 12.5% or less, or about 10% or less, or about 7.5% or less, or about 5% or less, or about 2.5% or less, or about 2% or less, or about 1% or less, or in a range from about 1% to about 25%, or about 2% to about 22.5%, or about 2.5% to about 20%, or about 5% to about 17.5%, or about 7.5% to about 15%, or about 10% to about 15%, or about 15.5% to about 15%, or any range or combination of ranges formed form these endpoints, of the distance D_{M}.

In embodiments, the depth of layers DOL₁, DOL₂, and DOL₃ are each 100 microns or less, or about 75 microns or less, or about 50 microns or less, or about 25 microns or less, or about 20 microns or less, or about 18 microns or less, or about 16 microns or less, or about 15 microns or less, or about 14 microns or less, or about 12 microns or less, or about 10 microns or less, or about 8 microns or less, or about 6 microns or less, or about 5 microns or less, or in a range from about 5 microns to about 100 microns, or about 6 microns to about 75 microns, or about 8 microns to about 50 microns, or about 10 microns to about 25 microns, or about 12 microns to about 20 microns, or about 14 microns to about 18 microns, or about 15 microns to about 16 microns, or any range or combination of ranges formed form these endpoints. As discussed above, the depth of layers DOL₁, DOL₂, and DOL₃ may all be equal to each other (or substantially equal to each other). However, it is also contemplated that one or more depth of layers DOL₁, DOL₂, and DOL₃ may be different from one or more other depth of layers DOL₁, DOL₂, and DOL₃.

Furthermore, in embodiments, the minimum distance D_{M} between two adjacent through-glass vias 30 is about 200 microns or less, or about 100 microns or less, or about 75 microns or less, or about 70 microns or less, or about 65 microns or less, or about 60 microns or less, or about 55 microns or less, or about 50 microns or less, or about 45 microns or less, or about 40 microns or less, or about 35 microns or less, or about 30 microns or less, or about 25 microns or less, or about 20 microns or less, or about 15 microns or less, or about 10 microns or less, or about 5 microns or less, or about 4 microns or less, or any range or combination of ranges formed form these endpoints. In embodiments, the minimum distance D_{M} is in a range from about 4 microns to about 100 microns, or about 5 microns to about 75 microns, or about 10 microns to about 70 microns, or about 15 microns to about 65 microns, or about 20 microns to about 60 microns, or about 25 microns to about 55 microns, or about 30 microns to about 50 microns, or about 35 microns to about 45 microns, or about 40 microns to about 45 microns, or any range or combination of ranges formed form these endpoints.

Four glass substrates 300, 310, 320, 330, which were all comprised of the same silicate glass composition with a refractive index of about 1.5, were subjected to different ion exchange processes to determine their respective failure loads. The glass substrates 300, 310, 320, 330 were all formed with through-glass vias therein before being subjected to the different ion exchange processes. Each glass substrate comprised through-glass vias with an average diameter of 80 microns and a pitch of 155 microns. Table 1 below provides the surface compressive stresses of the produced chemically strengthened regions within the glass substrates along with their depth of layers, as a result of the different ion exchange processes. As shown in Table 1 below, glass substrate 300 was not ion exchanged so chemically strengthened regions were not formed in this glass substrate. Glass substrate 310 was subjected to an ion exchange process so that chemically strengthened regions were formed with a relatively high surface compressive stress and a relatively high depth of layer. In particular, the depth of layer of glass substrate 310 was greater than 30% of the distance D_{M} (so that Equations (1)-(3) were not satisfied). Glass substrate 320 was subjected to an ion exchange process so that chemically strengthened regions were formed with a relatively high surface compressive stress but with a relatively low depth of layer. In particular, the depth of layer of glass substrate 320 was less than 30% of the distance D_{M} (so that Equations (1)-(3) were satisfied). And glass substrate 330 was subjected to an ion exchange process so that chemically strengthened regions were formed with a relatively low surface compressive stress and a relatively high depth of layer. In particular, the depth of layer of glass substrate 330 was greater than 30% of the distance D_{M} (so that Equations (1)-(3) were not satisfied).

TABLE 1

| Glass | Ion Exchange | Average Surface | Average Depth of | |
|---|---|---|---|---|
| Substrate | conditions | Compressive Stress (CS) | Layer (DOL) | |
| 300 | Not Ion Exchanged | N/A | N/A | |
| 310 | High CS/High DOL | 914 MPa | 26.4 | microns |
| 320 | High CS/Low DOL | 928 Mpa | 9.6 | microns |
| 330 | Low CS/High DOL | 313 Mpa | 24.1 | microns |

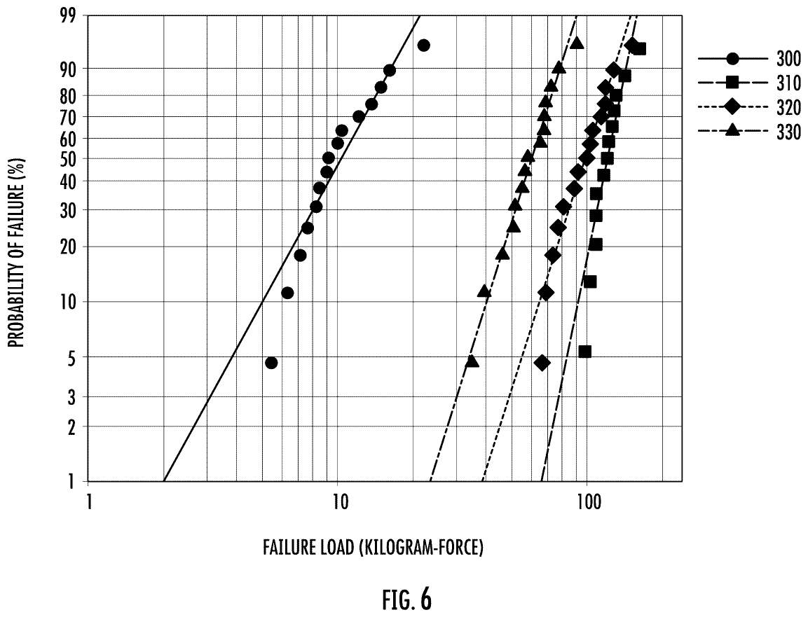

FIG. 6 shows the probability of failure of glass substrates 300, 310, 320, and 330 as exposed to different failure loads. The failure load (x-axis of FIG. 6) is measured according to the procedures in the ASTM standards C1499 and F394, the contents of which are incorporated herein by reference in their entirety. Furthermore, the probability of failure (y-axis in FIG. 6) is determined using the well-known Weibull statistical model.

As shown in FIG. 6, glass substrate 300, which was not subjected to an ion exchange process, was shown to have high probability of failure at the lowest failure loads. Therefore, glass substrate 300 would be expected to crack when subjected to these relatively low failure loads. However, glass substrate 320, which comprised the relatively high surface compressive stress and relatively low depth of layer, was shown to have high probability of failure at the highest failure loads. Therefore, glass substrate 320 would be expected to have the lowest cracking when subjected to these relatively high failure loads. Thus, FIG. 6 shows that a combination of a relatively high surface compressive stress and a relatively low depth of layer, as produced with the ion exchange processes disclosed herein, produces a glass substrate that is able to withstand increased failure loads.

Although glass substrate 310 is shown in FIG. 6 as also having a high probability of failure at the highest failure loads, glass substrate 310 comprised the relatively high depth of layer. Therefore, this substrate is more susceptible to the out-of-plane deformation, as discussed below, than glass substrate 320.

One of the limitations of ion-exchange is out-of-plane deformation of a substrate when exposed to an ion-exchange process. In particular, as a substrate is exposed to an ion exchange process, the substrate may experience volumetric expansion, which may cause out-of-plane deformation of the portion of the substrate comprising through-glass vias. Such out-of-plane deformation may result in a local increase in thickness of the substrate within the portion of the substrate that comprises the through-glass vias, which is disadvantageous.

In order to study the out-of-plane deformation on the substrates disclosed herein, a model was developed that leveraged a thermal analogy approach, in which ion diffusion is mimicked by the heat diffusion problem, followed by thermal stress calculation due to modeled temperature gradients. In the model, the initial substrate temperature, temperature applied on the ion exchanged surfaces of the substrate, as well as the density, specific heat capacity, thermal conductivity, and coefficient of thermal expansion of the substrate were adjusted to mimic a specific ion exchange recipe. The modeling was performed for various DOL distances on the following glass substrates: (i) a first glass substrate 400 with a thickness of 0.5 mm and comprising through-glass vias with an 80 micron diameter and 150 micron pitch, and (ii) a second glass substrate 410 with a thickness of 0.5 mm and comprising through-glass vias with an 80 micron diameter and 120 micron pitch, (iii) a third glass substrate 420 with a with a thickness of 0.2 mm and comprising through-glass vias with an 80 micron diameter and 150 micron pitch, and (iv) a fourth glass substrate 430 with a thickness of 1.1 mm and comprising through-glass vias with an 80 micron diameter and 150 micron pitch. In particular, in the modeling disclosed herein, the DOL layers refer to DOL₁ and DOL₂ at first and second major surfaces 22, 24, respectively, of the glass substrates.

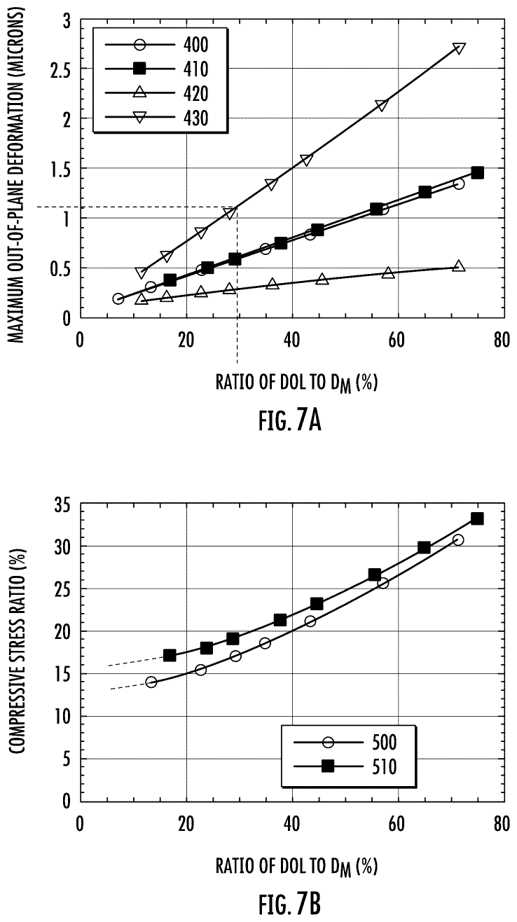

FIG. 7A is a plot of the ratio of DOL to distance Dy of the substrates 400, 410, 420, and 430 as a function of the maximum out-of-plane deformation of the substrates. As shown in FIG. 7A, smaller ratios of DOL to distance Dy correspond to smaller maximum out-of-plane deformations. In particular, when the ratio of DOL to distance D_{M} is 30% or less (such that Equations (1), (2), and/or (3) are satisfied), the maximum out-of-plane deformation of the substrates is about 1.00 micron or less. Therefore, in embodiments, the glass substrates disclosed herein with a thickness of 1.1 mm or less comprise an out-of-plane deformation of about 1.00 micron or less, or about 0.90 microns or less, or about 0.80 microns or less, or about 0.70 microns or less, or about 0.60 microns, or less, or about 0.50 microns or less, or about 0.40 microns or less, or about 0.30 microns or less, or about 0.20 microns or less, or about 0.10 microns or less, or about 0.05 microns or less, or about 0.00 microns, or any range or combination of ranges of these endpoints.

Furthermore, when the ratio of DOL to distance D_{M} is 50% or less (such that Equations (4), (5), and/or (6) are satisfied), the maximum out-of-plane deformation of the substrates is about 2.00 microns or less. Therefore, in embodiments, the glass substrates disclosed herein with a thickness of 1.1 mm or less comprise an out-of-plane deformation of about 2.00 micron or less, or about 1.90 microns or less, or about 1.80 microns or less, or about 1.70 microns or less, or about 1.60 microns or less, or about 1.50 microns or less, or about 1.40 microns or less, or about 1.30 microns or less, or about 1.20 microns or less, or about 1.10 microns or less, or about 1.00 microns or less, or about 0.90 microns or less, or about 0.80 microns or less, or about 0.70 microns or less, or about 0.60 microns, or less, or about 0.50 microns or less, or about 0.40 microns or less, or about 0.30 microns or less, or about 0.20 microns or less, or about 0.10 microns or less, or about 0.05 microns or less, or about 0.00 microns, or any range or combination of ranges of these endpoints.

FIG. 7B is a plot of the ratio of DOL to distance Dy vs. a ratio of compressive stress of two substrates 500, 510 that each comprise portions with through-glass vias and portions that do not comprise through-glass vias. In particular, the y-axis of FIG. 7B is a ratio of the decrease in compressive stress of each substrate 500, 510 in the portions of the substrate that comprise the through-glass vias vs. the compressive stress of the substrate in the portions of that substrate that do not comprise through-glass vias. Furthermore, substrate 500 comprises through-glass vias with a diameter of 80 microns and a pitch of 150 microns in the portions of the substrate that do comprise the through-glass vias, and substrate 510 comprises through-glass vias with a diameter of 80 microns and a pitch of 120 microns in the portions of the substrate that do comprise the through-glass vias. The presence of through-glass vias in a substrate allows the ion-exchanged surfaces to volumetrically expand more freely than portions of a substrate without through-glass vias disposed therein, resulting in lower compressive stress. FIG. 7B shows that smaller ratios of DOL to distance D_{M} correspond to smaller ratios of compressive stress, so that the substrate advantageously has a smaller dependence on the pitch to diameter ratio of the through-glass vias.

As discussed above, glass substrate 20 may comprise a glass material and/or a glass-based material. Glass substrate 20 may comprise a silicate glass composition. In the embodiments disclosed herein, the compositions of glass substrate 20 are advantageously well-suited for the ion exchange processes disclosed herein while also being resistant to alkali migration effects under the influence of an electric field, which is also commonly referred to as thermal poling. Such thermal poling effects can occur, for example, during metallization of through-glass vias 30 in subsequent downstream processing steps. When through-glass vias 30 are metallized, in order to provide an electrical connection in a chip assembly, for example, a voltage is applied to glass substrate 20 at an increased temperature in order to deposit the metal material within through-glass vias 30 and/or on first and second major surfaces 22, 24 of glass substrate 20. The applied voltage at the elevated temperature may create the thermal poling effect within glass substrate 20, in which alkali metal ions migrate away from one major surface of the glass substrate, and toward and/or out of a second major surface of a glass substrate 20. Due to the accumulation of alkali ions that migrated under the influence of the electric field, delamination and discoloration of the deposited metal material may occur, which ultimately results in electrical failure of the produced chip assembly.

Traditional glass compositions have not been shown to be well-suited for ion exchange processes while also being resistant to thermal poling effects. Instead, glass properties that traditionally produce chemically strengthened glass, thus making the glass well-suited for ion exchange processes, make the glass more susceptible to thermal poling effects. However, the inventors of the present disclosure discovered glass compositions that are well-suited for the ion exchange processes disclosed herein while also being resistant to thermal poling effects. Without wishing to being bound by theory, it is believed that the relatively high concentration of aluminum, the relatively low concentration of boron, and the combination of different alkali ions allows the glass compositions to be well-suited for the ion exchange processes disclosed herein while also being resistance to thermal poling effects.

The glass compositions of glass substrate 20 may be described as aluminosilicate glass compositions and may comprise SiO₂ and Al₂O₃. The glass compositions disclosed herein also comprise relatively high amounts of aluminum (Al₂O₃), relatively low amounts of boron (B₂O₃), and relatively high amounts of alkaline earth metals to enable the low thermal poling ability. Furthermore, in embodiments, the glass compositions disclosed herein also comprise a combination of different alkali ions to enable the ion exchangeability of the glass compositions. In particular, the relatively high amounts of aluminum (Al₂O₃), the relatively low amounts of boron (B₂O₃), and/or the combination of alkali ions allow the depth of layers (e.g., DOL₁, DOL₂, DOL₃), as produced by the ion exchange processes disclosed herein, to be smaller so that Equations (1), (2), (3), (4), (5), or (6) may be satisfied.

SiO₂ is the primary glass former in the glass compositions disclosed herein and may function to stabilize the network structure of glass substrate 20. A relatively higher concentration of SiO₂ may also reduce the etching rate of the etchants disclosed above, thus producing through-glass vias 30 with higher aspect ratios. The concentration of SiO₂ in the glass compositions disclosed herein and resultant glass article should be sufficiently high (e.g., greater than or equal to about 67 mol %) to provide basic glass forming capability. The amount of SiO₂ may be limited (e.g., less than or equal to about 85 mol %) to control the melting point of the glass composition and, thus, may aid in improving the meltability and the formability of the resulting glass article. In embodiments, the concentration of SiO₂ in the compositions disclosed herein is from about 67.0 mol % to about 85.0 mol %, or about 67.5 mol % to about 82.5 mol %, or about 68.0 mol % to about 82.0 mol %, or about 68.5 mol % to about 81.0 mol %, or about 70.0 mol % to about 80.0 mol %, or about 70.5 mol % to about 78.5 mol %, or about 71.0 mol % to about 76.0 mol %, or about 71.5 mol % to about 75.0 mol %, or about 72.0 mol % to about 75.0 mol %, or about 72.5 mol % to about 75.0 mol %, or about 73.0 mol % to about 75.0 mol %, or about 73.5 mol % to about 75.0 mol %, or about 74.0 mol % to about 75.0 mol %, or about 74.5 mol % to about 75.0 mol %, or about 67.0 mol % to about 72.5 mol %, or about 67.5 mol % to about 72.5 mol %, or about 70.0 mol % to about 72.5 mol %, or any range or combination of ranges formed from these endpoints.

Like SiO₂, Al₂O₃ may also stabilize the glass network of glass substrate 20 and additionally provide improved mechanical properties such as increased modulus. Furthermore, the amount of Al₂O₃ may also be tailored to the control the viscosity of the glass composition. The concentration of Al₂O₃ should be sufficiently high (e.g., greater than or equal to 1 mol %) such that the glass composition and the resultant glass article have the desired mechanical properties. Furthermore, the amount of Al₂O₃ should be sufficiently high to enable alkali mobility during the above disclosed ion exchange processes, but low enough to prevent unintended alkali migration during thermal poling (e.g., less than or equal to 10 mol %). In embodiments, the concentration of Al₂O₃ in the glass compositions disclosed herein is from about 1.0 mol % to about 11.00 mol %, or about 1.25 mol % to about 10.50 or about 1.5 mol % to about 10.00 mol %, or about 1.75 mol % to about 9.50 mol %, or about 2.0 mol % to about 9.00 mol %, or about 2.25 mol % to about 8.50 mol %, or about 2.5 mol % to about 8.00 mol %, or about 2.75 mol % to about 7.50 mol %, or about 3.0 mol % to about 7.00 mol %, or about 3.50 mol % to about 6.50 mol %, or about 4.00 mol % to about 6.00 mol %, or about 4.50 mol % to about 5.50 mol %, or about 4.50 mol % to about 5.00 mol %, or any range or combination of ranges formed from these endpoints.

The glass compositions disclosed herein may contain alkali oxides, such as Li₂O, Na₂O, and/or K₂O, to enable the ion exchangeability of the glass composition. The inclusion of Li₂O also reduces the softening point of the glass composition, thereby increasing the formability of the glass. In embodiments, the glass composition and the resultant glass substrate 20 may comprise Li₂O from about 0.00 mol % or greater, or about 0.01 mol % or greater, or about 0.02 mol % or greater, or about 0.05 mol % or greater, or about 0.08 mol % or greater, or about 0.10 mol % or greater, or about 0.15 mol % or greater, or about 0.20 mol % or greater, or about 0.25 mol % or greater, or about 0.30 mol % or greater, or about 0.35 mol % or greater, or about 0.40 mol % or greater, or about 0.45 mol % or greater, or about 0.50 mol % or greater. Additionally or alternatively, the glass composition and the resultant glass substrate 20 may comprise Li₂O from about 0.50 mol % or less, or about 0.45 mol % or less, or about 0.40 mol % or less, or about 0.35 mol % or less, or about 0.30 mol % or less, or about 0.25 mol % or less, or about 0.20 mol % or less, or about 0.15 mol % or less, or about 0.10 mol % or less, or about 0.08 mol % or less, or about 0.05 mol % or less, or about 0.02 mol % or less, or about 0.01 mol % or less. In embodiments, the glass composition and the resultant glass substrate 20 may comprise Li₂O from about 0.00 mol % to about 0.50 mol %, or about 0.01 mol % to about 0.45 mol %, or about 0.02 mol % to about 0.40 mol %, or about 0.05 mol % to about 0.35 mol %, or about 0.08 mol % to about 0.30 mol %, or about 0.10 mol % to about 0.25 mol %, or about 0.15 mol % to about 0.20 mol %, or any range or combination of ranges encompassing these endpoints.

In addition to aiding in ion exchangeability of the glass composition, Na₂O also decreases the melting point and improves formability of the glass composition. However, if too much Na₂O is added to the glass composition, the melting point may be too low or the thermal expansion too high. In embodiments, the concentration of Na₂O in the glass composition and the resultant glass substrate 20 may be about 4.0 mol % or greater, or about 5.0 mol % or greater, or about 6.0 mol % or greater, or about 7.0 mol % or greater, or about 8.0 mol % or greater, or about 9.0 mol % or greater, or about 10.0 mol % or greater, or about 11.0 mol % or greater, or about 12.0 mol % or greater. Additionally or alternatively, the concentration of Na₂O in the glass composition and the resultant glass substrate 20 may be about 12.0 mol % or less, or about 11.0 mol % or less, or about 10.0 mol % or less, or about 9.0 mol % or less, or about 8.0 mol % or less, or about 7.0 mol % or less, or about 6.0 mol % or less, or about 5.0 mol % or less. In embodiments, the concentration of Na₂O in the glass composition and the resultant glass substrate 20 is from about 4.0 mol % to about 12.0 mol %, or about 5.0 mol % to about 11.0 mol %, or about 6.0 mol % to about 10.0 mol %, or about 7.0 mol % to about 9.0 mol %, or about 8.0 mol % to about 9.0 mol %, or any range or combination of ranges encompassing these endpoints.

K₂O promotes ion exchange to increase the depth of the compression stress and decreases the melting point to improve formability of the glass composition. However, adding K₂O may cause the surface compressive stress and melting point to be too low. Therefore, the concentration of K₂O should be sufficiently low. In embodiments, the concentration of K₂O in the glass composition and the resultant glass substrate 20 is about 0.0 mol % or greater, or about 1.0 mol % or greater, or about 2.0 mol % or greater, or about 3.0 mol % or greater, or about 4.0 mol % or greater, or about 5.0 mol % or greater, or about 6.0 mol % or greater. Additionally or alternatively, the concentration of K₂O in the glass composition and the resultant glass substrate 20 is about 6.0 mol % or less, or about 5.0 mol % or less, or about 4.0 mol % or less, or about 3.0 mol % or less, or about 2.0 mol % or less, or about 1.0 mol % or less. In embodiments, the concentration of K₂O in the glass composition and the resultant glass substrate 20 is from about 0.0 mol % to about 6.0 mol %, or about 1.0 mol % to about 5.0 mol %, or about 2.0 mol % to about 4.0 mol %, or about 3.0 mol % to about 4.0 mol %, or any range or combination of ranges encompassing these endpoints.

In embodiments, the glass compositions and resultant glass substrates disclosed herein may comprise a combination of different alkali ions. Thus, the glass compositions and resultant glass substrates may comprise a mix of different alkali species. In some embodiments, the glass compositions and resultant glass substrates may comprise a 50/50 combination in mol % of two different alkali ions, such as for example, a 50/50 combination in mol % of Na and K. Such a combination of different alkali ions in the glass compositions helps to achieve the desired thermal poling effects.

In embodiments, the sum of Na₂O and K₂O (i.e., Na₂O+K₂O) may be limited to ensure a sufficient ion exchange performance. In embodiments, Na₂O+K₂O in the glass composition and the resultant glass substrate 20 may be about 15.0 mol % or less, or about 14.0 mol % or less, or about 13.0 mol % or less, or about 12.0 mol % or less, or about 11.0 mol % or less, or about 10.0 mol % or less, or about 9.0 mol % or less, or about 8.0 mol % or less, or about 7.0 mol % or less, or about 6.0 mol % or less, or about 5.0 mol % or less, or in a range from about 5.0 mol % to about 15.0 mol %, or about 6.0 mol % to about 14.0 mol %, or about 7.0 mol % to about 13.0 mol %, or about 8.0 mol % to about 12.0 mol %, or about 9.0 mol % to about 11.0 mol %, or about 10.0 mol % to about 11.0 mol %, or any range or combination of ranges encompassing these endpoints.

The sum of monovalent metal oxides (R₂O) in the glass composition and the resultant glass substrate 20 (i.e., R₂O=Li₂O+Na₂O+K₂O) may be about 15.0 mol % or less, or about 14.0 mol % or less, or about 13.0 mol % or less, or about 12.0 mol % or less, or about 11.0 mol % or less, or about 10.0 mol % or less, or about 9.0 mol % or less, or about 8.0 mol % or less, or about 7.0 mol % or less, or about 6.0 mol % or less, or about 5.0 mol % or less, or in a range from about 5.0 mol % to about 15.0 mol %, or about 6.0 mol % to about 14.0 mol %, or about 7.0 mol % to about 13.0 mol %, or about 8.0 mol % to about 12.0 mol %, or about 9.0 mol % to about 11.0 mol %, or about 10.0 mol % to about 11.0 mol %, or any range or combination of ranges encompassing these endpoints.

The glass compositions and resultant glass substrate 20 disclosed herein may contain relatively high amounts of boron to enable the ion exchangeability of the glass composition. In embodiments, the glass compositions and resultant glass substrate 20 disclosed herein may a concentration of B₂O₃ of about 2.0 mol % or greater, or about 2.5 mol % or greater, or about 3.0 mol % or greater, or about 3.5 mol % or greater, or about 4.0 mol % or greater, or about 4.5 mol % or greater, or about 5.0 mol % or greater, or about 5.5 mol % or greater, or about 6.0 mol % or greater, or about 6.5 mol % or greater, or about 7.0 mol % or greater, or about 7.5 mol % or greater, or about 8.0 mol % or greater, or about 8.5 mol % or greater, or about 9.0 mol % or greater, or about 9.5 mol % or greater, or about 10.0 mol % or greater. Additionally or alternatively, the glass compositions and resultant glass substrate 20 disclosed herein may a concentration of B₂O₃ of about 10.0 mol % or less, or about 9.5 mol % or less, or about 9.0 mol % or less, or about 8.5 mol % or less, or about 8.0 mol % or less, or about 7.5 mol % or less, or about 7.0 mol % or less, or about 6.5 mol % or less, or about 6.0 mol % or less, or about 5.5 mol % or less, or about 5.0 mol % or less, or about 4.5 mol % or less, or about 4.0 mol % or less, or about 3.5 mol % or less, or about 3.0 mol % or less, or about 2.5 mol % or less, or about 2.0 mol % or less. In embodiments, the glass compositions and resultant glass substrate 20 disclosed herein may a concentration of B₂O₃ is from about 2.0 mol % to about 10.0 mol %, or about 2.5 mol % to about 9.5 mol %, or about 3.0 mol % to about 9.0 mol %, or about 3.5 mol % to about 8.5 mol %, or about 4.0 mol % to about 8.0 mol %, or about 4.5 mol % to about 7.5 mol %, or about 5.0 mol % to about 7.0 mol %, or about 5.5 mol % to about 6.5 mol %, or about 6.0 mol % to about 6.5 mol %, or any range or combination of ranges encompassing these endpoints.

In embodiments, the glass compositions and the resultant glass substrate 20 may further comprise Zirconia (ZrO₂). Zirconia may impart improved mechanical properties and may also improve the ion exchange performance. In embodiments, the glass composition and resultant glass substrate 20 may comprise ZrO₂ from about 0.0 mol % or greater, or about 0.1 mol % or greater, or about 0.2 mol % or greater, or about 0.3 mol % or greater, or about 0.4 mol % or greater, or about 0.5 mol % or greater. Additionally or alternatively, the glass composition and resultant glass substrate 20 may comprise ZrO₂ from about 5.0 mol % or less, or about 4.0 mol % or less, or about 3.0 mol % or less, or about 2.0 mol % or less, or about 1.0 mol % or less. In embodiments, the glass composition and resultant glass substrate 20 may comprise ZrO₂ from about 0.0 mol % to about 5.0 mol %, or about 1.0 mol % to about 4.0 mol %, or about 2.0 mol % to about 3.0 mol %, or any range or combination of ranges encompassing these endpoints.

The glass compositions disclosed herein may contain alkaline earth metal oxides, such as CaO, MgO, BaO, and/or SrO, to enable the ion exchangeability of the glass compositions. In embodiments, the glass compositions and resultant glass substrates 20 disclosed herein may comprise CaO from about 0.0 mol % or greater, or about 0.5 mol % or greater, or about 1.0 mol % or greater, or about 1.5 mol % or greater, or about 2.0 mol % or greater, or about 2.5 mol % or greater, or about 3.0 mol % or greater, or about 3.5 mol % or greater, or about 4.0 mol % or greater, or about 4.5 mol % or greater, or about 5.0 mol % or greater, or about 5.5 mol % or greater, or about 6.0 mol % or greater, or about 6.5 mol % or greater, or about 7.0 mol % or greater, or about 7.5 mol % or greater. Additionally or alternatively, the glass compositions and resultant glass substrates 20 disclosed herein may comprise CaO from about 7.5 mol % or less or about 7.0 mol % or less, or about 6.5 mol % or less, or about 6.0 mol % or less, or about 5.5 mol % or less, or about 5.0 mol % or less, or about 4.5 mol % or less, or about 4.0 mol % or less, or about 3.5 mol % or less, or about 3.0 mol % or less, or about 2.5 mol % or less, or about 2.0 mol % or less, or about 1.5 mol % or less, or about 1.0 mol % or less. In embodiments, the glass compositions and resultant glass substrates 20 disclosed herein may comprise CaO from about 0.0 mol % to about 7.5 mol %, or about 0.5 mol % to about 7.0 mol %, or about 1.0 mol % to about 6.5 mol %, or about 1.5 mol % to about 6.0 mol %, or about 2.0 mol % to about 5.5 mol %, or about 2.5 mol % to about 5.0 mol %, or about 3.0 mol % to about 4.5 mol %, or about 3.5 mol % to about 4.0 mol %, or any range or combination of ranges encompassing these endpoints.

In embodiments, the glass compositions and resultant glass substrates 20 disclosed herein may comprise MgO from about 0.0 mol % or greater, or about 0.5 mol % or greater, or about 1.0 mol % or greater, or about 1.5 mol % or greater, or about 2.0 mol % or greater, or about 2.5 mol % or greater, or about 3.0 mol % or greater, or about 3.5 mol % or greater, or about 4.0 mol % or greater, or about 4.5 mol % or greater, or about 5.0 mol % or greater, or about 5.5 mol % or greater, or about 6.0 mol % or greater, or about 6.5 mol % or greater, or about 7.0 mol % or greater, or about 7.5 mol % or greater. Additionally or alternatively, the glass compositions and resultant glass substrates 20 disclosed herein may comprise MgO from about 7.5 mol % or less or about 7.0 mol % or less, or about 6.5 mol % or less, or about 6.0 mol % or less, or about 5.5 mol % or less, or about 5.0 mol % or less, or about 4.5 mol % or less, or about 4.0 mol % or less, or about 3.5 mol % or less, or about 3.0 mol % or less, or about 2.5 mol % or less, or about 2.0 mol % or less, or about 1.5 mol % or less, or about 1.0 mol % or less. In embodiments, the glass compositions and resultant glass substrates 20 disclosed herein may comprise MgO from about 0.0 mol % to about 7.5 mol %, or about 0.5 mol % to about 7.0 mol %, or about 1.0 mol % to about 6.5 mol %, or about 1.5 mol % to about 6.0 mol %, or about 2.0 mol % to about 5.5 mol %, or about 2.5 mol % to about 5.0 mol %, or about 3.0 mol % to about 4.5 mol %, or about 3.5 mol % to about 4.0 mol %, or any range or combination of ranges encompassing these endpoints.

In embodiments, the glass compositions and resultant glass substrates 20 disclosed herein may comprise BaO from about 0.0 mol % or greater, or about 0.5 mol % or greater, or about 1.0 mol % or greater, or about 1.5 mol % or greater, or about 2.0 mol % or greater, or about 2.5 mol % or greater, or about 3.0 mol % or greater. Additionally or alternatively, the glass compositions and resultant glass substrates 20 disclosed herein may comprise BaO from about 3.0 mol % or less, or about 2.5 mol % or less, or about 2.0 mol % or less, or about 1.5 mol % or less, or about 1.0 mol % or less. In embodiments, the glass compositions and resultant glass substrates 20 disclosed herein may comprise BaO from about 0.0 mol % to about 3.0 mol %, or about 0.5 mol % to about 2.5 mol %, or about 1.0 mol % to about 2.0 mol %, or about 1.5 mol % to about 2.0 mol %, or any range or combination of ranges encompassing these endpoints.

In embodiments, the glass compositions and resultant glass substrates 20 disclosed herein may comprise SrO from about 0.0 mol % or greater, or about 0.5 mol % or greater, or about 1.0 mol % or greater, or about 1.5 mol % or greater, or about 2.0 mol % or greater, or about 2.5 mol % or greater, or about 3.0 mol % or greater. Additionally or alternatively, the glass compositions and resultant glass substrates 20 disclosed herein may comprise SrO from about 3.0 mol % or less, or about 2.5 mol % or less, or about 2.0 mol % or less, or about 1.5 mol % or less, or about 1.0 mol % or less. In embodiments, the glass compositions and resultant glass substrates 20 disclosed herein may comprise SrO from about 0.0 mol % to about 3.0 mol %, or about 0.5 mol % to about 2.5 mol %, or about 1.0 mol % to about 2.0 mol %, or about 1.5 mol % to about 2.0 mol %, or any range or combination of ranges encompassing these endpoints.

In embodiments, the glass compositions and resultant glass substrates 20 disclosed herein may comprise ZnO from about 0.0 mol % or greater, or about 0.5 mol % or greater, or about 1.0 mol % or greater, or about 1.5 mol % or greater, or about 2.0 mol % or greater, or about 2.5 mol % or greater, or about 3.0 mol % or greater. Additionally or alternatively, the glass compositions and resultant glass substrates 20 disclosed herein may comprise ZnO from about 3.0 mol % or less, or about 2.5 mol % or less, or about 2.0 mol % or less, or about 1.5 mol % or less, or about 1.0 mol % or less. In embodiments, the glass compositions and resultant glass substrates 20 disclosed herein may comprise ZnO from about 0.0 mol % to about 3.0 mol %, or about 0.5 mol % to about 2.5 mol %, or about 1.0 mol % to about 2.0 mol %, or about 1.5 mol % to about 2.0 mol %, or any range or combination of ranges encompassing these endpoints.

The sum of divalent metal oxides (RO) in the glass composition and the resultant glass substrate 20 (i.e., RO=CaO+MgO+BaO+SrO+ZnO) may be about 10.0 mol % or less, or about 9.0 mol % or less, or about 8.0 mol % or less, or about 7.0 mol % or less, or about 6.0 mol % or less, or about 5.0 mol % or less, or about 4.0 mol % or less, or about 3.0 mol % or less, or about 2.0 mol % or less, or in a range from about 2.0 mol % to about 10.0 mol %, or about 3.0 mol % to about 9.0 mol %, or about 4.0 mol % to about 8.0 mol %, or about 5.0 mol % to about 7.0 mol %, or about 6.0 mol % to about 7.0 mol %, or any range or combination of ranges encompassing these endpoints.

A ratio of the monovalent metal oxides in mol % to divalent metal oxides in mol % (i.e., R₂O/RO) may be from about 1.0 to about 10.0, or about 2.0 to about 9.0, or about 3.0 to about 8.0, or about 4.0 to about 7.0, or about 5.0 to about 6.0, or any range or combination of ranges encompassing these endpoints.

A ratio of the total concentration of monovalent metal oxides in mol % and the divalent metal oxides in mol % to the concentration of Al₂O₃ in mol % (i.e., ((R₂O+RO)/Al₂O₃) may be about 20.0 or less, or about 18.0 or less, or about 16.0 or less, or about 14.0 or less, or about 12.0 or less, or about 10.0 or less, or about 8.0 or less, or about 6.0 or less, or about 4.0 or less, or about 2.0 or less, or in a range from about 2.0 to about 20.0, or about 4.0 to about 18.0, or about 6.0 to about 16.0, or about 8.0 to about 14.0, or about 10.0 to about 12, or any range or combination of ranges encompassing these endpoints.

A ratio of the total concentration of monovalent metal oxides in mol % and the divalent metal oxides in mol % to the total concentration of Al₂O₃ in mol % and B₂O₃ in mol % combined (i.e., ((R₂O+RO)/(Al₂O₃+B₂O₃)) may be about 3.0 or less, or about 2.5 or less, or about 2.0 or less, or about 1.5, or less, or about 1.0 or less, or in a range from about 1.0 to about 3.0, or about 1.5 to about 2.5, or about 2.0 to about 2.5, or any range or combination of ranges encompassing these endpoints.

A difference between the concentration of monovalent metal oxides in mol % and the concentration of Al₂O₃ in mol % (i.e., R₂O—Al₂O₃) may be about 15.0 mol % or less, or about 14.0 mol % or less, or about 13.0 mol %, or less, or about 12.0 mol % or less, or about 11.0 mol % or less, or about 10.0 mol % or less, or about 9.0 mol % or less, or about 8.0 mol % or less, or about 7.0 mol % or less, or about 6.0 mol % or less, or about 5.0 mol % or less, or about 4.0 mol % or less, or about 3.0 mol % or less, or in a range from about 3.0 mol % to about 15.0 mol %, or about 4.0 mol % to about 14.0 mol %, or about 5.0 mol % to about 13.0 mol %, or about 6.0 mol % to about 12.0 mol %, or about 7.0 mol % to about 11.0 mol %, or about 8.0 mol % to about 10.0 mol %, or about 9.0 mol % to about 10.0 mol %, or any range or combination of ranges encompassing these endpoints.

A difference between the concentration of divalent metal oxides in mol % and the concentration of Al₂O₃ in mol % (i.e., RO—Al₂O₃) may be about 10.0 mol % or less, or about 9.0 mol % or less, or about 8.0 mol % or less, or about 7.0 mol % or less, or about 6.0 mol % or less, or about 5.0 mol % or less, or about 4.0 mol % or less, or about 3.0 mol % or less, or about 2.0 mol %, or less, or about 1.0 mol % or less, or about 0.0 mol % or less, or about-0.5 mol % or less, or about-1.0 mol % or less, or about-1.5 mol % or less, or about-2.0 mol % or less, or in a range from about-2.0 mol % to about 10.0 mol %, or about-1.5 mol % to about 9.0 mol %, or about-1.0 mol % to about 8.0 mol %, or about-0.5 mol % to about 7.0 mol %, or about 0.0 mol % to about 6.0 mol %, or about 1.0 mol % to about 5.0 mol %, or about 2.0 mol % to about 4.0 mol %, or about 3.0 mol % to about 4.0 mol %, or any range or combination of ranges encompassing these endpoints.

A difference between the total concentration of monovalent metal oxides in mol % and divalent metal oxides in mol % with the concentration of Al₂O₃ in mol % (i.e., (R₂O+RO)—Al₂O₃)) may be about 20.0 mol % or less, or about 18.0 mol % or less, or about 16.0 mol % or less, or about 14.0 mol % or less, or about 12.0 mol % or less, or about 10.0 mol % or less, or about 8.0 mol % or less, or about 6.0 mol % or less, or about 4.0 mol % or less, or about 2.0 mol % or less, or in a range from about 2.0 mol % to about 20.0 mol %, or about 4.0 mol % to about 18.0 mol %, or about 6.0 mol % to about 16.0 mol %, or about 8.0 mol % to about 14.0 mol %, or about 10.0 mol % to about 12 mol %, or any range or combination of ranges encompassing these endpoints.

The glass compositions and resultant glass substrates 20 disclosed herein may further comprise TiO₂ from about 0.0 mol % or greater, or about 0.5 mol % or greater, or about 1.0 mol % or greater or about 1.5 mol % or greater or about 2.0 mol % or greater, or about 2.5 mol % or greater, or about 3.0 mol % or greater. Additionally or alternatively, the glass compositions and resultant glass substrates 20 disclosed herein may further comprise TiO₂ from about 3.0 mol % or less, or about 2.5 mol % or less, or about 2.0 mol % or less, or about 1.5 mol % or less, or about 1.0 mol % or less, or about 0.5 mol % or less. In embodiments, the glass compositions and resultant glass substrates 20 disclosed herein may further comprise TiO₂ from about 0.0 mol % to about 3.0 mol %, or about 0.5 mol % to about 2.5 mol %, or about 1.0 mol % to about 2.0 mol %, or about 1.5 mol % to about 2.0 mol %, or any range or combination of ranges encompassing these endpoints.

The glass compositions and resultant glass substrates 20 disclosed herein may further comprise chlorine (Cl) from about 0.0 mol % or greater, or about 0.1 mol % or greater, or about 0.2 mol % or greater, or about 0.3 mol % or greater, or about 0.4 mol % or greater, or about 0.5 mol % or greater. Additionally or alternatively, the glass compositions and resultant glass substrates 20 disclosed herein may comprise Cl from about 0.5 mol % or less, or about 0.4 mol % or less or about 0.3 mol % or less, or about 0.2 mol % or less, or about 0.1 mol % or less. In embodiments, the glass compositions and resultant glass substrates 20 disclosed herein may comprise Cl from about 0.0 mol % to about 0.5 mol %, or about 0.1 mol % to about 0.4 mol %, or about 0.2 mol % to about 0.3 mol %, or any range or combination of ranges encompassing these endpoints.

The glass compositions and resultant glass substrates 20 disclosed herein may further comprise fluorine (F) from about 0.00 mol % or greater, or about 0.01 mol % or greater, or about 0.02 mol % or greater, or about 0.03 mol % or greater, or about 0.04 mol % or greater, or about 0.05 mol % or greater. Additionally or alternatively, the glass compositions and resultant glass substrates 20 disclosed herein may comprise F from about 0.05 mol % or less, or about 0.04 mol % or less or about 0.03 mol % or less, or about 0.02 mol % or less, or about 0.01 mol % or less. In embodiments, the glass compositions and resultant glass substrates 20 disclosed herein may comprise F from about 0.00 mol % to about 0.05 mol %, or about 0.01 mol % to about 0.04 mol %, or about 0.02 mol % to about 0.03 mol %, or any range or combination of ranges encompassing these endpoints.

The glass compositions and resultant glass substrates 20 disclosed herein may comprise SnO₂ from about 0.0 mol % or greater, or about 0.01 mol % or greater, or about 0.02 mol % or greater, or about 0.03 mol % or greater, or about 0.04 mol % or greater, or about 0.05 mol % or greater, or about 0.08 mol % or greater, or about 0.1 mol % or greater, or about 0.2 mol % or greater, or about 0.3 mol % or greater. Additionally or alternatively, the glass compositions and resultant glass substrates 20 disclosed herein may comprise SnO₂ from about 0.3 mol % or less, or about 0.2 mol % or less, or about 0.1 mol % or less, or about 0.08 mol % or less, or about 0.05 mol % or less, or about 0.04 mol % or less, or about 0.03 mol % or less, or about 0.02 mol % or less, or about 0.01 mol % or less. In embodiments, the glass compositions and resultant glass substrates 20 disclosed herein may comprise SnO₂ from about 0.0 mol % to about 0.3 mol %, or about 0.01 mol % to about 0.2 mol %, or about 0.02 mol % to about 0.1 mol %, or about 0.03 mol % to about 0.08 mol %, or about 0.04 mol % to about 0.05 mol %, or any range or combination of ranges encompassing these endpoints.

Table 2 below some exemplary glass compositions according to embodiments of the present disclosure.

TABLE 2

| | Exemplary Minimum | Exemplary Maximum | |
|---|---|---|---|
| Component | Concentration | Concentration | |
| SiO₂ | 67.0 mol. % | 85.0 | mol. % |
| Na₂O | 5.0 mol. % | 10.0 | mol. % |
| K₂O | 0.0 mol. % | 5.0 | mol. % |
| B₂O₃ | 2.5 mol. % | 10.0 | mol. % |
| Al₂O₃ | 1.0 mol. % | 5.0 | mol. % |
| CaO | 0.0 mol. % | 7.5 | mol. % |
| MgO | 0.0 mol. % | 7.5 | mol. % |
| BaO | 0.0 mol. % | 3.0 | mol. % |
| SrO | 0.0 mol. % | 3.0 | mol. % |
| TiO₂ | 0.0 mol. % | 3.0 | mol. % |
| ZnO | 0.0 mol. % | 3.0 | mol. % |
| Li₂O | 0.0 mol. % | 0.5 | mol. % |
| ZrO₂ | 0.0 mol. % | 0.5 | mol. % |
| Cl | 0.0 mol. % | 0.2 | mol. % |
| F | 0.0 mol. % | 0.05 | mol. % |

| | | |
|---|---|---|
| R₂O/RO | 1.0 | 5.0 |

In embodiments, the glass composition and the resultant glass article may have a coefficient of thermal expansion (CTE) of about 6.0 ppm/° C. or greater, or about 7.0 ppm/° C. or greater, or about 8.0 ppm/° C. or greater, or about 9.0 ppm/° C. or greater, or in a range from about 6.0 ppm/° C. to about 9.0 ppm/° C., or about 7.0 ppm/° C. to about 8.0 ppm/° C., or any range or combination of ranges encompassing these endpoints. As described herein, CTE is measured in accordance with ASTM E228-85 over the temperature range of 25° C. to 300° C.

As discussed hereinabove, the glass compositions and the resultant glass substrates 20 described herein may have increased Young's modulus such that the glass compositions and the resultant glass substrates 20 are more elastic. As described herein, the Young's modulus is measured in accordance with ASTM C623. In embodiments, the glass composition and the resultant glass substrate 20 may have a Young's modulus of about 60 GPa or greater, or about 65 GPa or greater, or about 70 GPa or greater, or about 75 GPa or greater, or about 80 GPa or greater, or about 85 GPa or greater, or about 90 GPa or greater, or about 95 GPa or greater, or about 100 GPa or greater. Additionally or alternatively, the Young's modulus is about 100 GPa or less, or about 95 GPa or less, or about 90 GPa or less, or about, or about 85 GPa or less, or about 80 GPa or less, or about 75 GPa or less, or about 70 GPa or less, or about 65 GPa or less, or about 60 GPa or less. In embodiments, the Young's modulus is from about 60 GPa to about 100 GPa, or about 65 GPa to about 95 GPa, or about 70 GPa to about 90 GPa, or about 75 GPa to about 85 GPa, or about 80 GPa to about 85 GPa, or any range or combination of ranges encompassing these endpoints.

In embodiments, the glass composition and the resultant glass substrate 20 may have a shear modulus of about 20 GPa or greater, or about 25 GPa or greater, or about 30 GPa or greater, or about 35 GPa or greater, or about 40 GPa or greater, or about 45 GPa or greater, or about 50 GPa or greater. Additionally or alternatively, the shear modulus is about 50 GPa or less, or about 45 GPa or less, or about 40 GPa or less, or about 35 GPa or less, or about 30 GPa or less, or about 25 GPa or less, or about 20 GPa or less. In embodiments, the shear modulus is from about 20 GPa to about 50 GPa, or about 25 GPa to about 45 GPa, or about 30 GPa to about 40 GPa, or about 35 GPa to about 40 GPa, or any range or combination of ranges encompassing these endpoints. As described herein, the shear modulus is measured in accordance with ASTM C623.

In embodiments, the glass composition and the resultant glass substrate 20 may have a strain point of about 450° C. or greater, or about 500° C. or greater, or about 525° C. or greater, or about 550° C. or greater, or about 575° C. or greater, or about 600° C. or greater, or about 625° C. or greater, or about 650° C. or greater, or about 675° C. or greater, or about 700° C. or greater, or in a range from about 450° C. to about 700° C., or about 500° C. to about 675° C., or about 525° C. to about 650° C., or about 550° C. to about 625° C., or about 575° C. to about 625° C., or about 600° C. to about 625° C., or any range or combination of ranges encompassing these endpoints. As described herein, the strain point refers to the temperature at which the viscosity of the glass composition is 1×10^{14.68} poise as measured in accordance with ASTM C598.

In embodiments, the glass composition and the resultant glass substrate 20 may have an annealing point of about 500° C. or greater, or about 525° C. or greater, or about 550° C. or greater, or about 575° C. or greater, or about 600° C. or greater, or about 625° C. or greater, or about 650° C. or greater, or about 675° C. or greater, or about 700° C. or greater, or in a range from about 500° C. to about 700° C., or about 525° C. to about 675° C., or about 550° C. to about 650° C., or about 575° C. to about 625° C., or about 600° C. to about 625° C., or any range or combination of ranges encompassing these endpoints. As described herein, the annealing point refers to the temperature at which the viscosity of the glass composition is 1×10^{13.18} poise as measured in accordance with ASTM C598.

In embodiments, the glass composition and the resultant glass substrate 20 may have a density of about 2.2 g/cm³ or greater, or about 2.3 g/cm³ or greater, or about 2.4 g/cm³ or greater, or about 2.5 g/cm³ or greater, or about 2.6 g/cm³ or greater, or about 2.7 g/cm³ or greater, or about 2.8 g/cm³ or greater, or about 2.9 g/cm³ or greater. Additionally or alternatively, the density is from about 2.9 g/cm³ or less, or about 2.8 g/cm³ or less, or about 2.7 g/cm³ or less, or about 2.6 g/cm³ or less, or about 2.5 g/cm³ or less, or about 2.4 g/cm³ or less, or about 2.3 g/cm³ or less, or about 2.2 g/cm³ or less. In embodiments, the density is from about 2.2 g/cm³ to about 2.9 g/cm³, or about 2.3 g/cm³ to about 2.8 g/cm³, or about 2.4 g/cm³ to about 2.7 g/cm³, or about 2.5 g/cm³ to about 2.6 g/cm³, or any range or combination of ranges encompassing these endpoints. Density, as described herein, is measured by the buoyancy method of ASTM C693-93.

In embodiments, the glass composition and the resultant glass substrate 20 described herein may have a Poisson's ratio of about 0.18 or greater, or about 0.19 or greater, or about 0.20 or greater, or about 0.21 or greater, or about 0.22 or greater, or about 0.23 or greater, or about 0.24 or greater. Additionally or alternatively, the Poisson's ratio is about 0.24 or less or about 0.23 or less, or about 0.22 or less, or about 0.21 or less, or about 0.20 or less, or about 0.19 or less, or about 0.18 or less. In embodiments, the Poisson's ratio is from about 0.18 to about 0.24, or about 0.19 to about 0.23, or about 0.20 to about 0.22, or about 0.21 to about 0.22, or any range or combination of ranges encompassing these endpoints. As described herein, Poisson's ratio is measured in accordance with ASTM C623.

In embodiments, the glass composition and the resultant glass substrate 20 may have a refractive index of about 1.4 or greater, or about 1.5 or greater, or about 1.6 or greater, or about 1.7 or greater, or about 1.8 or greater, or about 1.9 or greater, or about 2.0 or greater, or about 2.1 or greater, or about 2.2 or greater, or about 2.3 or greater, or about 2.4 or greater, or about 2.5 or greater, or about 2.6 or greater, or about 2.7 or greater, or about 2.8 or greater, or about 2.9 or greater, or about 3.0 or greater. In embodiments, the refractive index is in a range from about 1.4 to about 3.0, or about 1.5 to about 2.9, or about 1.6 to about 2.8, or about 1.7 to about 2.7, or about 1.8 to about 2.6, or about 1.9 to about 2.5, or about 2.0 to about 2.4, or about 2.1 to about 2.3, or about 2.2 to about 2.3, or any range or combination of ranges encompassing these endpoints. As described herein, refractive index is measured in accordance with ASTM E1967.

In embodiments, the glass composition and the resultant glass substrate 20 may have a stress optical coefficient, as discussed above, of about 2.5 nm/mm/MPa or greater, or about 2.0 nm/mm/MPa or greater, or about 3.5 nm/mm/MPa or greater, or about 4.0 nm/mm/MPa or greater, or in a range from about 2.5 nm/mm/MPa to about 4.0 nm/mm/MPa, or about 3.0 nm/mm/MPa to about 3.5 nm/mm/MPa.

In embodiments, the glass composition and the resultant glass substrate may have a liquidus temperature from about 700° C. to about 1600° C., or about 750° C. to about 1500° C., or about 800° C. to about 1400° C., or about 900° C. to about 1200° C., or about 100° C. to about 1100° C., or any range or combination of ranges encompassing these endpoints. As described herein, the liquidus temperature is the temperature at which the glass composition begins to devitrify as determined with the gradient furnace method according to ASTM C829-81.

In embodiments, the glass composition and the resultant glass substrate may have a thermal conductivity of about 0.6 W/m·K or greater, or about 0.7 W/m·K or greater, or about 0.8 W/m·K or greater, or about 0.9 W/m·K or greater, or about 1.0 W/m·K or greater, or about 1.1 W/m·K or greater, or about 1.2 W/m·K or greater. Additionally or alternatively, the thermal conductivity is about 1.2 W/m·K or less, or about 1.1 W/m·K or less, or about 1.0 W/m·K or less, or about 0.9 W/m·K or less, or about 0.8 W/m·K or less, or about 0.7 W/m·K or less, or about 0.6 W/m·K or less. In embodiments, the thermal conductivity is from about 0.6 W/m·K to about 1.2 W/m·K, or about 0.7 W/m·K to about 1.1 W/m·K, or about 0.8 W/m·K to about 1.0, or about 0.9 W/m·K to about 1.0 W/m·K, or any range or combination of ranges encompassing these endpoints. Thus, embodiments of the present disclosure encompass a microelectronic article with a glass substrate 20 comprising the above disclosed thermal conductivity. As used herein, thermal conductivity is measured as discussed in ASTM E1461-13, which is incorporated by reference herein.

In order that various embodiments be more readily understood, reference is made to the following examples, which are intended to illustrate various embodiments of the glass compositions described herein.

TABLE 3

| | Exemplary | | Exemplary | | Exemplary | | Exemplary | |
|---|---|---|---|---|---|---|---|---|
| Component | Example 1 | | Example 2 | | Example 3 | | Example 4 | |
| SiO₂ | 69.8 | mol % | 70.0 | mol % | 69.6 | mol % | 69.6 | mol % |
| Al₂O₃ | 1.3 | mol % | 1.3 | mol % | 1.3 | mol % | 1.3 | mol % |
| B₂O₃ | 8.4 | mol % | 8.4 | mol % | 8.4 | mol % | 8.5 | mol % |
| Na₂O | 6.7 | mol % | 6.8 | mol % | 6.9 | mol % | 7.0 | mol % |
| K₂O | 5.1 | mol % | 5.0 | mol % | 5.0 | mol % | 5.1 | mol % |
| MgO | 0.02 | mol % | 3.3 | mol % | 6.0 | mol % | 3.0 | mol % |
| CaO | 0.03 | mol % | 0.04 | mol % | 0.05 | mol % | 1.2 | mol % |
| ZnO | 5.5 | mol % | 2.4 | mol % | 0.02 | mol % | 2.6 | mol % |
| TiO₂ | 2.6 | mol % | 2.6 | mol % | 2.5 | mol % | 1.4 | mol % |
| Cl | 0.3 | mol % | 0.3 | mol % | 0.3 | mol % | 0.3 | mol % |
| TOTAL | 100 | mol % | 100 | mol % | 100 | mol % | 100 | mol % |
| Total R₂O | 12.1 | mol % | 11.8 | mol % | 11.9 | mol % | 12.0 | mol % |
| Total RO | 5.6 | mol % | 5.7 | mol % | 6.0 | mol % | 6.9 | mol % |
| (R₂O + RO)/Al₂O₃ | 9.6 | | 11.9 | | 13.9 | | 12.6 | |
| (R₂O + RO)/(Al₂O₃ + B₂O₃) | 1.3 | | 1.6 | | 1.9 | | 1.7 | |
| (RO) − Al₂O₃ | −1.2 | mol % | 2.0 | mol % | 4.7 | mol % | 3.0 | mol % |
| (R₂O) − Al₂O₃ | 10.8 | mol % | 10.5 | mol % | 10.6 | mol % | 10.7 | mol % |
| (R₂O + RO) − Al₂O₃ | 16.4 | mol % | 16.2 | mol % | 16.6 | mol % | 17.6 | mol % |
| Strain Point | 511° | C. | 515° | C. | 520° | C. | 519° | C. |
| Annealing Point | 551° | C. | 556° | C. | 560° | C. | 559° | C. |
| Softening Point | 725° | C. | 729° | C. | 731° | C. | 728° | C. |
| Temperature at which | 1318° | C. | 1341° | C. | 1360° | C. | 1320° | C. |
| Viscosity is 200 Poise | | | | | | | | |
| Temperature at which | 1265° | C. | 1285° | C. | 1304° | C. | 1267° | C. |
| Viscosity is 300 Poise | | | | | | | | |
| Temperature at which | 937° | C. | 943° | C. | 960° | C. | 942° | C. |
| Viscosity is 35 Kilopoise | | | | | | | | |
| Temperature at which | 863° | C. | 865° | C. | 881° | C. | 867° | C. |
| Viscosity is 200 | | | | | | | | |
| Kilopoise | | | | | | | | |
| CTE at 25° C. to 300° C. | 7.9 | ppm/° C. | 7.4 | ppm/° C. | 7.5 | ppm/° C. | | |
| Density | 2.54 | g/cm³ | 2.49 | g/cm³ | 2.45 | g/cm³ | 2.49 | g/cm³ |
| Liquidus Temperature | 795° | C. | 800° | C. | | | | |
| Liquidus Viscosity | 1.8E+06 P | | 1.5E+06 P | | | | | |
| Liquidus Phase | Tridymite | | Tridymite | | | | | |
| Poisson's Ratio | 0.21 | | 0.21 | | 0.21 | | 0.21 | |
| Shear Modulus | 30.3 | GPa | 30.5 | GPa | 30.6 | GPa | 30.7 | GPa |
| Young's Modulus | 73.4 | GPa | 73.8 | GPa | 74.0 | GPa | 74.5 | GPa |

TABLE 4

| | Exemplary | | Exemplary | | Exemplary | | Exemplary | |
|---|---|---|---|---|---|---|---|---|
| Component | Example 5 | | Example 6 | | Example 7 | | Example 8 | |
| SiO₂ | 69.4 | mol % | 69.6 | mol % | 69.9 | mol % | 69.9 | mol % |
| Al₂O₃ | 1.6 | mol % | 1.3 | mol % | 1.3 | mol % | 1.4 | mol % |
| B₂O₃ | 8.5 | mol % | 8.6 | mol % | 8.6 | mol % | 8.4 | mol % |
| Na₂O | 6.8 | mol % | 6.9 | mol % | 6.9 | mol % | 9.7 | mol % |
| K₂O | 4.8 | mol % | 5.1 | mol % | 5.0 | mol % | 5.0 | mol % |
| MgO | 5.8 | mol % | 5.7 | mol % | 2.0 | mol % | 2.1 | mol % |
| CaO | 1.3 | mol % | 2.6 | mol % | 6.0 | mol % | 3.3 | mol % |
| ZnO | 0.4 | mol % | 0.0 | mol % | 0.0 | mol % | 0.0 | mol % |
| TiO₂ | 1.3 | mol % | 0.0 | mol % | 0.0 | mol % | 0.0 | mol % |
| Cl | 0.2 | mol % | 0.3 | mol % | 0.3 | mol % | 0.3 | mol % |
| TOTAL | 100 | mol % | 100 | mol % | 100 | mol % | 100 | mol % |
| Total R₂O | 11.6 | mol % | 12.0 | mol % | 11.9 | mol % | 14.6 | mol % |
| Total RO | 7.5 | mol % | 8.2 | mol % | 8.0 | mol % | 5.4 | mol % |
| (R₂O + RO)/Al2O3 | 11.4 | | 15.7 | | 15.4 | | 14.6 | |
| (R₂O + RO)/(Al₂O₃ + B₂O₃) | 1.8 | | 2.0 | | 2.0 | | 2.0 | |
| (RO) − Al₂O₃ | 5.5 | mol % | 7.0 | mol % | 6.7 | mol % | 4.0 | mol % |
| (R₂O) − Al₂O₃ | 9.9 | mol % | 10.7 | mol % | 10.6 | mol % | 13.2 | mol % |
| (R₂O + RO) − Al₂O₃ | 17.4 | mol % | 18.9 | mol % | 18.6 | mol % | 18.7 | mol % |
| Strain Point | 523° | C. | 524° | C. | 537° | C. | 520° | C. |
| Annealing Point | 562° | C. | 563° | C. | 573° | C. | 557° | C. |
| Softening Point | 734° | C. | 734° | C. | 730° | C. | | |
| Temperature at which | 1370° | C. | 1336° | C. | 1296° | C. | 1266° | C. |
| Viscosity is 200 Poise | | | | | | | | |
| Temperature at which | 1314° | C. | 1282° | C. | 1245° | C. | 1216° | C. |
| Viscosity is 300 Poise | | | | | | | | |
| Temperature at which | 963° | C. | 948° | C. | 935° | C. | 910° | C. |
| Viscosity is 35 Kilopoise | | | | | | | | |
| Temperature at which | 882° | C. | 872° | C. | 864° | C. | 842° | C. |
| Viscosity is 200 | | | | | | | | |
| Kilopoise | | | | | | | | |
| Density | 2.45 | g/cm³ | 2.45 | g/cm³ | 2.48 | g/cm³ | 2.48 | g/cm³ |

| Poisson's Ratio | 0.2 | |
|---|---|---|
| Shear Modulus | 30.7 | GPa |
| Young's Modulus | 74.4 | GPa |

TABLE 5

| | Exemplary | | Exemplary | | Exemplary | | Exemplary | |
|---|---|---|---|---|---|---|---|---|
| Component | Example 9 | | Example 10 | | Example 11 | | Example 12 | |
| SiO₂ | 74.9 | mol % | 74.9 | mol % | 74.9 | mol % | 74.9 | mol % |
| Al₂O₃ | 3.9 | mol % | 3.9 | mol % | 3.9 | mol % | 3.9 | mol % |
| B₂O₃ | 3.0 | mol % | 3.0 | mol % | 3.0 | mol % | 5.4 | mol % |
| Na₂O | 7.5 | mol % | 7.5 | mol % | 5.5 | mol % | 6.5 | mol % |
| K₂O | 3.3 | mol % | 3.3 | mol % | 5.3 | mol % | 5.3 | mol % |
| SrO | 2.6 | mol % | 0.0 | mol % | 0.0 | mol % | 0.0 | mol % |
| BaO | 2.3 | mol % | 2.3 | mol % | 2.3 | mol % | 1.3 | mol % |
| ZnO | 0.0 | mol % | 2.6 | mol % | 2.6 | mol % | 2.6 | mol % |
| TiO₂ | 2.4 | mol % | 2.4 | mol % | 2.4 | mol % | 0.0 | mol % |
| SnO₂ | 0.2 | mol % | 0.2 | mol % | 0.2 | mol % | 0.2 | mol % |
| Cl | | | | | | | | |
| TOTAL | 100 | mol % | 100 | mol % | 100 | mol % | 100 | mol % |
| Total R₂O | 10.8 | mol % | 10.8 | mol % | 10.8 | mol % | 11.8 | mol % |
| Total RO | 4.9 | mol % | 4.9 | mol % | 4.9 | mol % | 3.9 | mol % |
| (R₂O + RO)/Al₂O₃ | 4.1 | | 3.4 | | 3.4 | | 3.4 | |
| (R₂O + RO)/(Al₂O₃ + B₂O₃) | 2.3 | | 1.9 | | 1.9 | | 1.4 | |
| (RO) − Al₂O₃ | 1.0 | mol % | −1.6 | mol % | −1.6 | mol % | −2.6 | mol % |
| (R₂O) − Al₂O₃ | 6.9 | mol % | 6.9 | mol % | 6.9 | mol % | 7.9 | mol % |
| (R₂O + RO) − Al₂O₃ | 11.8 | mol % | 11.8 | mol % | 11.8 | mol % | 11.8 | mol % |

TABLE 6

| | Exemplary | | Exemplary | | Exemplary | |
|---|---|---|---|---|---|---|
| Component | Example 13 | | Example 14 | | Example 15 | |
| SiO₂ | 74.9 | mol % | 74.9 | mol % | 74.9 | mol % |
| Al₂O₃ | 3.9 | mol % | 4.9 | mol % | 6.9 | mol % |
| B₂O₃ | 3.0 | mol % | 5.4 | mol % | 0.0 | mol % |
| Na₂O | 10.8 | mol % | 6.5 | mol % | 7.5 | mol % |
| K₂O | 0.0 | mol % | 4.3 | mol % | 3.3 | mol % |
| MgO | 0.0 | mol % | 0.0 | mol % | 2.6 | mol % |
| CaO | 0.0 | mol % | 0.0 | mol % | 2.3 | mol % |
| BaO | 2.3 | mol % | 0.0 | mol % | 0.0 | mol % |
| ZnO | 2.6 | mol % | 2.6 | mol % | 0.0 | mol % |
| TiO₂ | 2.4 | mol % | 1.3 | mol % | 2.4 | mol % |
| SnO₂ | 0.2 | mol % | 0.2 | mol % | 0.2 | mol % |
| TOTAL | 100 | mol % | 100 | mol % | 100 | mol % |
| Total R₂O | 10.8 | mol % | 10.8 | mol % | 10.8 | mol % |
| Total RO | 4.9 | mol % | 2.6 | mol % | 4.9 | mol % |
| (R₂O + RO)/Al₂O₃ | 3.4 | | 2.2 | | 2.3 | |
| (R₂O + RO)/(Al₂O₃ + B₂O₃) | 1.9 | | 1.1 | | 2.3 | |
| (RO) − Al₂O₃ | −1.6 | mol % | −4.9 | mol % | −2.0 | mol % |
| (R₂O) − Al₂O₃ | 6.9 | mol % | 5.9 | mol % | 3.9 | mol % |
| (R₂O + RO) − Al₂O₃ | 11.8 | mol % | 8.5 | mol % | 8.8 | mol % |

| Strain Point | 589° | C. |
|---|---|---|
| Annealing Point | 639° | C. |
| Softening Point | 883° | C. |
| Temperature at which | 1730° | C. |
| Viscosity is 200 Poise | | |
| Temperature at which | 1665° | C. |
| Viscosity is 300 Poise | | |
| Temperature at which | 1216° | C. |
| Viscosity is 35 Kilopoise | | |
| Temperature at which | 1101° | C. |
| Viscosity is 200 | | |
| Kilopoise | | |
| CTE at 25° C. to 300° C. | 7.4 | ppm/° C. |
| Density | 2.43 | g/cm³ |
| Liquidus Temperature | 1055° | C. |
| Liquidus Viscosity | 4.7E+05 P | |
| Liquidus Phase | Diopside | |
| Poisson's Ratio | 0.2 | |
| Shear Modulus | 30.1 | GPa |
| Young's Modulus | 72.2 | GPa |

TABLE 7

| | Exemplary | | Exemplary | | Exemplary | | Exemplary | | Exemplary | | Exemplary | |
|---|---|---|---|---|---|---|---|---|---|---|---|---|
| | Example | | Example | | Example | | Example | | Example | | Example | |
| Component | 16 | | 17 | | 18 | | 19 | | 20 | | 21 | |
| SiO₂ | 77.3 | mol % | 78.7 | mol % | 79.6 | mol % | 80.1 | mol % | 78.8 | mol % | 80.7 | mol % |
| Al₂O₃ | 3.7 | mol % | 3.5 | mol % | 2.2 | mol % | 1.3 | mol % | 1.3 | mol % | 1.3 | mol % |
| B₂O₃ | 2.6 | mol % | 2.5 | mol % | 2.5 | mol % | 2.5 | mol % | 4.1 | mol % | 4.1 | mol % |
| Na₂O | 5.1 | mol % | 4.9 | mol % | 5.0 | mol % | 5.1 | mol % | 5.0 | mol % | 4.6 | mol % |
| K₂O | 4.6 | mol % | 4.3 | mol % | 4.3 | mol % | 4.3 | mol % | 4.0 | mol % | 3.8 | mol % |
| BaO | 2.3 | mol % | 2.1 | mol % | 2.3 | mol % | 2.3 | mol % | 2.3 | mol % | 1.9 | mol % |
| ZnO | 2.2 | mol % | 1.9 | mol % | 2.2 | mol % | 2.2 | mol % | 2.2 | mol % | 1.8 | mol % |
| TiO₂ | 2.1 | mol % | 1.9 | mol % | 2.1 | mol % | 2.1 | mol % | 2.1 | mol % | 1.7 | mol % |
| SnO₂ | 0.6 | mol % | 0.6 | mol % | 0.6 | mol % | 0.2 | mol % | 0.2 | mol % | 0.2 | mol % |
| Total R₂O | 9.7 | mol % | 9.2 | mol % | 9.3 | mol % | 9.4 | mol % | 9.0 | mol % | 8.4 | mol % |
| Total RO | 4.5 | mol % | 4.0 | mol % | 4.5 | mol % | 4.5 | mol % | 4.5 | mol % | 3.7 | mol % |
| (RO) − Al₂O₃ | 0.8 | mol % | 0.5 | mol % | 2.2 | mol % | 3.2 | mol % | 3.2 | mol % | 2.4 | mol % |
| (R2O) − Al₂O₃ | 6.0 | mol % | 5.7 | mol % | 7.1 | mol % | 8.2 | mol % | 7.7 | mol % | 7.1 | mol % |
| (R₂O + RO) − | 10.5 | mol % | 9.7 | mol % | 11.5 | mol % | 12.6 | mol % | 12.2 | mol % | 10.8 | mol % |
| Al₂O₃ | | | | | | | | | | | | |
| Strain Point | 544° | C. | 546° | C. | 537° | C. | 532° | C. | 545° | C. | 548° | C. |
| Annealing | 588° | C. | 591° | C. | 583° | C. | 576° | C. | 588° | C. | 593° | C. |
| Point | | | | | | | | | | | | |
| Softening | 805° | C. | 814° | C. | 798° | C. | 790° | C. | 790° | C. | 802° | C. |
| Point | | | | | | | | | | | | |
| Density | 2.53 | g/cm³ | 2.51 | g/cm³ | 2.53 | g/cm³ | 2.53 | g/cm³ | 2.54 | g/cm³ | 2.49 | g/cm³ |
| Poisson's | 0.2 | | 0.2 | | 0.2 | | 0.2 | | 0.2 | | 0.2 | |
| Ratio | | | | | | | | | | | | |
| Shear | 30.1 | GPa | 30.2 | GPa | 30.1 | GPa | 30.2 | GPa | 30.9 | GPa | 31.1 | GPa |
| Modulus | | | | | | | | | | | | |
| Young's | 72.1 | GPa | 72.3 | GPa | 72.0 | GPa | 72.1 | GPa | 73.8 | GPa | 74.0 | GPa |
| Modulus | | | | | | | | | | | | |
| Liquidus | 865° | C. | 980° | C. | 1010° | C. | 1125° | C. | 1090° | C. | 1135° | C. |
| Temperature | | | | | | | | | | | | |
| Liquidus | 4.5E+06 | P | 4.2E+05 | P | 1.1E+05 | P | 1.4E+04 | P | 1.9E+04 | P | 1.5E+04 | P |
| Viscosity | | | | | | | | | | | | |

TABLE 8

| | Exemplary | | Exemplary | | Exemplary | | Exemplary | | Exemplary | |
|---|---|---|---|---|---|---|---|---|---|---|
| Component | Example 22 | | Example 23 | | Example 24 | | Example 25 | | Example 26 | |
| SiO₂ | 77.3 | mol % | 77.3 | mol % | 77.3 | mol % | 77.3 | mol % | 78.7 | mol % |
| Al₂O₃ | 3.7 | mol % | 3.7 | mol % | 3.7 | mol % | 3.7 | mol % | 3.5 | mol % |
| B₂O₃ | 2.6 | mol % | 2.6 | mol % | 2.6 | mol % | 2.6 | mol % | 2.5 | mol % |
| Na₂O | 9.1 | mol % | 8.1 | mol % | 9.1 | mol % | 8.1 | mol % | 8.9 | mol % |
| K₂O | 0.6 | mol % | 1.6 | mol % | 0.6 | mol % | 1.6 | mol % | 0.3 | mol % |
| MgO | 0.0 | mol % | 2.4 | mol % | 2.4 | mol % | 0.0 | mol % | 1.1 | mol % |
| CaO | 4.3 | mol % | 4.3 | mol % | 4.3 | mol % | 4.3 | mol % | 4.8 | mol % |
| BaO | 2.4 | mol % | 0.0 | mol % | 0.0 | mol % | 2.4 | mol % | 0.0 | mol % |
| SnO₂ | 0.2 | mol % | 0.2 | mol % | 0.2 | mol % | 0.2 | mol % | 0.2 | mol % |
| CTE at | 6.9 | ppm/° C. | 6.9 | ppm/° C. | 6.8 | ppm/° C. | 7.0 | ppm/° C. | 6.6 | ppm/° C. |
| 300° C. | | | | | | | | | | |
| Modeled | 72.8 | GPa | 71.2 | GPa | 71.0 | GPa | 73.1 | GPa | 71.4 | GPa |
| Young's | | | | | | | | | | |
| Modulus | | | | | | | | | | |
| Modeled | 586° | C. | 635° | C. | 632° | C. | 590° | C. | 643° | C. |
| Annealing | | | | | | | | | | |
| Point | | | | | | | | | | |
| Modeled | 2.50 | g/cm³ | 2.39 | g/cm³ | 2.39 | g/cm³ | 2.50 | g/cm³ | 2.39 | g/cm³ |

Density

TABLE 9

| | Exemplary | | Exemplary | |
|---|---|---|---|---|
| Component | Example 27 | | Example 28 | |
| SiO₂ | 75.8 | mol % | 67.3 | mol % |
| Al₂O₃ | 3.8 | mol % | 10.1 | mol % |
| B₂O₃ | 2.9 | mol % | 6.0 | mol % |
| Li₂O | 0 | mol % | 0 | mol % |
| Na₂O | 7.0 | mol % | 11.0 | mol % |
| K₂O | 3.0 | mol % | 2.4 | mol % |
| MgO | 0.02 | mol % | 2.53 | mol % |
| CaO | 0.09 | mol % | 0.04 | mol % |
| BaO | 2.26 | mol % | 0.01 | mol % |
| SrO | 0.01 | mol % | 0.00 | mol % |
| SnO₂ | 0.12 | mol % | 0.1 | mol % |
| TiO₂ | 2.40 | ml % | 0.02 | mol % |
| ZnO | 2.54 | mol % | 0.01 | mol % |
| ZrO₂ | 0.03 | mol % | 0.45 | mol % |
| (R₂O + RO)/Al₂O₃ | 3.24 | | 1.58 | |
| Strain Point | 539° | C. | 540° | C. |
| Annealing Point | 582° | C. | 585° | C. |
| Softening Point | 786° | C. | 813° | C. |
| CTE at 300° C. | 7.0 | ppm/° C. | 8.1 | ppm/° C. |
| Density | 2.5 | g/cm³ | 2.4 | g/cm³ |

| | | | |
|---|---|---|---|
| Young's Modulus | GPa | 71.2 | GPa |

| | | |
|---|---|---|
| Poisson's Ratio | 0.20 | 0.21 |

| | | |
|---|---|---|
| Liquidus Viscosity | 3.37E+06 P | 4.5E+06 P |

According to a first aspect, a glass substrate is disclosed that comprises a plurality of through-glass vias extending through the glass substrate, adjacent through-glass vias being separated by a minimum average distance D_{M}. And, the glass substrate comprising a chemically strengthened region with a depth of layer such that the depth of layer extends from a surface of the glass substrate to a distance within a bulk of the glass substrate, the chemically strengthened region having a higher compressive stress than a remainder of the glass substrate, and wherein the depth of layer of the chemically strengthened region is about 30% or less of the distance D_{M}.

According to a second aspect, the glass substrate of the first aspect, wherein the depth of layer of the chemically strengthened region is about 25% or less of the distance D_{M}.

According to a third aspect, the glass substrate of the second aspect, wherein the depth of layer of the chemically strengthened region is about 22.5% or less of the distance D_{M}.

According to a fourth aspect, the glass substrate of any one of the first through third aspects, wherein the glass substrate comprises a first major surface and an opposing second major surface, the chemically strengthened region comprises a first chemically strengthened region and a second chemically strengthened region, the first chemically strengthened region comprises a first depth of layer DOL₁ that extends from the first major surface to a first distance D₁ within the bulk of the substrate, the second chemically strengthened region comprises a second depth of layer DOL₂ that extends from the second major surface to a second distance D₂ within the bulk of the substrate, the first depth of layer DOL₁ of the first chemically strengthened region is about 30% or less of the distance D_{M}, and the second depth of layer DOL₂ of the second chemically strengthened region is about 30% or less of the distance D_{M}.

According to a fifth aspect, the glass substrate of the fourth aspect, wherein the first distance D₁ is equal to the second distance D₂.

According to a sixth aspect, the glass substrate of the fourth of fifth aspect, wherein a through-glass via of the plurality of through-glass vias comprises an interior surface, the chemically strengthened region further comprises a third chemically strengthened region, the third chemically strengthened region comprises a third depth of layer DOL₃ that extends from the interior surface to a third distance D₃ within the bulk of the substrate, and the third depth of layer DOL₃ of the third chemically strengthened region is about 30% or less of the distance D_{M}.

According to a seventh aspect, the glass substrate of the sixth aspect, wherein the first depth of layer DOL₁, the second depth of layer DOL₂, and the third depth of layer DOL₃ are each about 20 microns or less.

According to an eighth aspect, the glass substrate of the seventh aspect, wherein the first depth of layer DOL₁, the second depth of layer DOL₂, and the third depth of layer DOL₃ are each about 10 microns or less.

According to a ninth aspect, the glass substrate of any one of the sixth through eighth aspects, wherein the third distance D₃ is equal to the first distance D₁ and to the second distance D₂.

According to a tenth aspect, the glass substrate of any one of the fourth through ninth aspects, wherein the compressive stress of the first chemically strengthened region is equal to the compressive stress of the second chemically strengthened region.

According to an eleventh aspect, the glass substrate of any one of the first through tenth aspects, wherein the distance D_{M} is about 80 microns or less.

According to a twelfth aspect, the glass substrate of any one of the first through eleventh aspects, wherein the distance D_{M} is about 60 microns or less.

According to a thirteenth aspect, the glass substrate of the eleventh or twelfth aspects, wherein the distance D_{M} is in a range from about 15 microns to about 65 microns.

According to a fourteenth aspect, the glass substrate of any one of the first through thirteenth aspects, wherein the chemically strengthened region comprises a surface compressive stress of about 200 MPa or greater.

According to a fifteenth aspect, the glass substrate of the fourteenth aspect, wherein the surface compressive stress is about 400 MPa or greater.

According to a sixteenth aspect, the glass substrate of any one of the first through fifteenth aspects, wherein the plurality of through-glass vias each comprise an aspect ratio of about 10:1 or greater.

According to a seventh aspect, the glass substrate of the sixteenth aspect, wherein the aspect ratio is about 15:1 or greater.

According to an eighteenth aspect, the glass substrate of the seventeenth aspect, wherein the aspect ratio is about 20:1 or greater.

According to a nineteenth aspect, the glass substrate of any one of the first through eighteenth aspects, wherein a composition of the glass substrate comprises the following components SiO₂ from about 67.0 mol % to about 85.0 mol %, Al₂O₃ from about 1.0 mol % to about 5.0 mol %, and B₂O₃ from about 2.5 mol % to about 10.0 mol %.

According to a twentieth aspect, the glass substrate of the nineteenth aspect, wherein the composition further comprises Na₂O from about 5.0 mol % to about 10.0 mol %, and K₂O from about 0.0 mol % to about 5.0 mol %.

According to a twenty-first aspect, the glass substrate of the nineteenth or twentieth aspect, wherein a ratio of monovalent metal oxides in mol % to divalent metal oxides in mol % in the glass composition is from about 1.0 to about 10.0.

According to a twenty-second aspect, the glass substrate of any one of the nineteenth through twenty-first aspects, wherein a ratio of a total concentration of monovalent metal oxides in mol % and divalent metal oxides in mol % to a concentration of Al₂O₃ in mol % is about 20.0 or less.

According to a twenty-third aspect, the glass substrate of any one of the nineteenth through twenty-second aspects, wherein a coefficient of thermal expansion of the glass substrate is about 6.0 ppm/° C. or greater over a temperature range from 25° C. to 300° C.

According to a twenty-fourth aspect, the glass substrate of the twenty-third aspect, wherein the coefficient of thermal expansion of the glass substrate is from about 6.0 ppm/° C. to about 9.0 ppm/° C. over the temperature range from 25° C. to 300° C.

According to a twenty-fifth aspect, the glass substrate of any one of the first through twenty-fourth aspects, wherein a maximum out-of-plane deformation of the glass substrate is about 1.00 microns or less.

According to a twenty-sixth aspect, the glass substrate of the twenty-fifth aspect, wherein a thickness of the glass substrate is about 1.1 mm or less.

According to a twenty-seventh aspect, a glass comprising a composition with the following components SiO₂ from about 67.0 mol % to about 85.0 mol %, Al₂O₃ from about 1.0 mol % to about 5.0 mol %, B₂O₃ from about 2.5 mol % to about 10.0 mol %, Na₂O from about 5.0 mol % to about 10.0 mol %, and K₂O from about 0.0 mol % to about 5.0 mol %, wherein a ratio of monovalent metal oxides in mol % to divalent metal oxides in mol % in the glass composition is from about 1.0 to about 10.0, and wherein a ratio of a total concentration of the monovalent metal oxides in mol % and the divalent metal oxides in mol % to a concentration of Al₂O₃ in mol % in the glass composition is about 20.0 or less.

According to a twenty-eighth aspect, the glass of the twenty-seventh aspect, wherein the ratio of monovalent metal oxides in mol % to divalent metal oxides in mol % in the glass composition is from about 3.0 to about 8.0.

According to a twenty-ninth aspect, the glass of the twenty-seventh or twenty-eighth aspects, wherein the ratio of the total concentration of the monovalent metal oxides in mol % and the divalent metal oxides in mol % to the concentration of Al₂O₃ in mol % in the glass composition is about 16.0 or less.

According to a thirtieth aspect, the glass of any one of the twenty-seventh through twenty-ninth aspects, wherein a ratio of a total concentration of the monovalent metal oxides in mol % and the divalent metal oxides in mol % to a concentration of Al₂O₃ in mol % and B₂O₃ in mol % combined is about 3.0 or less.

According to a thirty-first aspect, the glass of the thirtieth aspect, wherein a ratio of a total concentration of the monovalent metal oxides in mol % and the divalent metal oxides in mol % to the concentration of Al₂O₃ in mol % and B₂O₃ in mol % combined is about 2.0 or less.

According to a thirty-second aspect, the glass of any one of the twenty-seventh through thirty-first aspects, wherein a difference between a concentration of the monovalent metal oxides in mol % and a concentration of Al₂O₃ in mol % is about 15.0 mol % or less.

According to a thirty-third aspect, the glass of any one of the twenty-seventh through thirty-second aspects, wherein a difference between a concentration of the divalent metal oxides in mol % and a concentration of Al₂O₃ in mol % is about 10.0 mol % or less.

According to a thirty-fourth aspect, the glass of any one of the twenty-seventh through thirty-third aspects, wherein the composition further comprises CaO from about 0.0 mol % to about 7.5 mol %, MgO from about 0.0 mol % to about 7.5 mol %, BaO from about 0.0 mol % to about 3.0 mol %, SrO from about 0.0 mol % to about 3.0 mol %, TiO₂ from about 0.0 mol % to about 3.0 mol %, ZnO from about 0.0 mol % to about 3.0 mol %, Li₂O from about 0.0 mol % to about 0.5 mol %, ZrO₂ from about 0.0 mol % to about 0.5 mol %, Cl from about 0.0 mol % to about 0.2 mol %, and F from about 0.0 mol % to about 0.05 mol %.

According to a thirty-fifth aspect, the glass of any one of the twenty-seventh through thirty-fourth aspects, wherein a coefficient of thermal expansion of the glass is about 6.0 ppm/° C. or greater over a temperature range from 25° C. to 300° C.

According to a thirty-sixth aspect, the glass of the thirty-fifth aspect, wherein the coefficient of thermal expansion of the glass is from about 6.0 ppm/° C. to about 9.0 ppm/° C. over the temperature range from 25° C. to 300° C.

According to a thirty-seventh aspect, a method of forming a glass substrate with a chemically strengthened region, the method comprising immersing the glass substrate in a salt bath at a temperature from about 350° C. to about 525° C., wherein a composition of the glass substrate comprises the following components SiO₂ from about 67.0 mol % to about 85.0 mol %, Al₂O₃ from about 1.0 mol % to about 5.0 mol %, and B₂O₃ from about 2.5 mol % to about 10.0 mol %, a ratio of monovalent metal oxides in mol % to divalent metal oxides in mol % in the glass composition being from about 1.0 to about 10.0.

According to a thirty-eighth aspect, the method of the thirty-seventh aspect, wherein the glass substrate is immersed in the salt bath for a duration from about 5 minutes to about 40 hours.

According to a thirty-ninth aspect, the method of the thirty-seventh or thirty-eighth aspects, wherein the salt bath is at a temperature from about 400° C. to about 475° C.

According to a fortieth aspect, the method of any one of the thirty-seventh through thirty-ninth aspect, further comprising exchanging smaller monovalent metal ions in the glass substrate with larger metal ions of the salt bath to form the chemically strengthened region in the glass substrate.

According to a forty-first aspect, the method of any one of the thirty-seventh through fortieth aspects, wherein the glass substrate comprises a plurality of through-glass vias.

According to a forty-second aspect, the method of the forty-first aspect, wherein the plurality of through-glass vias each comprise an aspect ratio of about 10:1 or greater.

According to a thirty-third aspect, the method of the forty-second aspect, wherein the aspect ratio is about 15:1 or greater.

According to a forty-fourth aspect, the method of the forty-third aspect, wherein the aspect ratio is about 20:1 or greater.

According to a forty-fifth aspect, the method of any one of the thirty-seventh through forty-fourth aspects, wherein a ratio of monovalent metal oxides to divalent metal oxides in the glass composition is from about 1.0 mol % to about 10.0 mol %.

According to a forty-sixth aspect, the method of any one of the thirty-seventh through forty-fifth aspects, wherein a ratio of a total concentration of monovalent metal oxides in mol % and divalent metal oxides in mol % to a concentration of Al₂O₃ in mol % in the glass composition is about 20.0 or less.

According to a forty-seventh aspect, the method of any one of the thirty-seventh through forty-sixth aspects, wherein a ratio of a total concentration of monovalent metal oxides in mol % and divalent metal oxides in mol % to a concentration of Al₂O₃ in mol % and B₂O₃ in mol % combined in the glass composition is about 3.0 or less.

According to a forty-eighth aspect, the method of any one of the thirty-seventh through forty-seventh aspects, wherein a difference between a concentration of monovalent metal oxides in mol % and a concentration of Al₂O₃ in mol % in the glass composition is about 15.0 mol % or less.

According to a forty-ninth aspect, the method of any one of the thirty-seventh through forty-eighth aspects, wherein a difference between a concentration of the divalent metal oxides in mol % and a concentration of Al₂O₃ in mol % in the glass composition is about 10.0 mol % or less.

According to a fiftieth aspect, the method of any one of the thirty-seventh through forty-ninth aspects, wherein the composition further comprises Na₂O from about 5.0 mol % to about 10.0 mol %, and K₂O from about 0.0 mol % to about 5.0 mol %.

According to a fifty-first aspect, the method of any one of the thirty-seventh through fiftieth aspect, wherein the composition further comprises CaO from about 0.0 mol % to about 7.5 mol %, MgO from about 0.0 mol % to about 7.5 mol %, BaO from about 0.0 mol % to about 3.0 mol %, SrO from about 0.0 mol % to about 3.0 mol %, TiO₂ from about 0.0 mol % to about 3.0 mol %, ZnO from about 0.0 mol % to about 3.0 mol %, Li₂O from about 0.0 mol % to about 0.5 mol %, ZrO₂ from about 0.0 mol % to about 0.5 mol %, Cl from about 0.0 mol % to about 0.2 mol %, and F from about 0.0 mol % to about 0.05 mol %.

According to a fifty-second aspect, the method of any one of the thirty-seventh through fifty-first aspects, wherein a coefficient of thermal expansion of the glass substrate is about 6.0 ppm/° C. or greater over a temperature range from 25° C. to 300° C.

According to a fifty-third aspect, the method of the fifty-second aspect, wherein the coefficient of thermal expansion of the glass substrate is from about 6.0 ppm/° C. to about 9.0 ppm/° C. over the temperature range from 25° C. to 300° C.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A glass substrate comprising:
a plurality of through-glass vias extending through the glass substrate, adjacent through-glass vias being separated by a minimum average distance D_{M}; and
a chemically strengthened region with a depth of layer such that the depth of layer extends from a surface of the glass substrate to a distance within a bulk of the glass substrate, the chemically strengthened region having a higher compressive stress than a remainder of the glass substrate,
wherein the depth of layer of the chemically strengthened region is about 30% or less of the distance D_{M}.

2. The glass substrate of claim 1, wherein the depth of layer of the chemically strengthened region is about 25% or less of the distance D_{M}.

3. The glass substrate of claim 1, wherein:
the glass substrate comprises a first major surface and an opposing second major surface,
the chemically strengthened region comprises a first chemically strengthened region and a second chemically strengthened region,
the first chemically strengthened region comprises a first depth of layer DOL₁ that extends from the first major surface to a first distance D₁ within the bulk of the substrate,
the second chemically strengthened region comprises a second depth of layer DOL₂ that extends from the second major surface to a second distance D₂ within the bulk of the substrate,
the first depth of layer DOL₁ of the first chemically strengthened region is about 30% or less of the distance D_{M}, and
the second depth of layer DOL₂ of the second chemically strengthened region is about 30% or less of the distance D_{M}.

4. The glass substrate of claim 3, wherein the first distance D₁ is equal to the second distance D₂.

5. The glass substrate of claim 3, wherein:
a through-glass via of the plurality of through-glass vias comprises an interior surface,
the chemically strengthened region further comprises a third chemically strengthened region,
the third chemically strengthened region comprises a third depth of layer DOL₃ that extends from the interior surface to a third distance D₃ within the bulk of the substrate, and
the third depth of layer DOL₃ of the third chemically strengthened region is about 30% or less of the distance D_{M}.

6. The glass substrate of claim 5, wherein the first depth of layer DOL₁, the second depth of layer DOL₂, and the third depth of layer DOL₃ are each about 20 microns or less.

7. The glass substrate of claim 5, wherein the third distance D₃ is equal to the first distance D₁ and to the second distance D₂.

8. The glass substrate of claim 3, wherein the compressive stress of the first chemically strengthened region is equal to the compressive stress of the second chemically strengthened region.

9. The glass substrate of claim 1, wherein the distance D_{M} is about 80 microns or less.

10. The glass substrate of claim 1, wherein the chemically strengthened region comprises a surface compressive stress of about 200 MPa or greater.

11. The glass substrate of claim 1, wherein the plurality of through-glass vias each comprise an aspect ratio of about 10:1 or greater.

12. The glass substrate of claim 1, wherein a composition of the glass substrate comprises the following components:
SiO₂ from about 67.0 mol % to about 85.0 mol %,
Al₂O₃ from about 1.0 mol % to about 5.0 mol %, and
B₂O₃ from about 2.5 mol % to about 10.0 mol %.

13. The glass substrate of claim 12, wherein the composition further comprises:
Na₂O from about 5.0 mol % to about 10.0 mol %, and
K₂O from about 0.0 mol % to about 5.0 mol %.

14. The glass substrate of claim 12, wherein a ratio of monovalent metal oxides in mol % to divalent metal oxides in mol % in the glass composition is from about 1.0 to about 10.0.

15. The glass substrate of claim 12, wherein a ratio of a total concentration of monovalent metal oxides in mol % and divalent metal oxides in mol % to a concentration of Al₂O₃ in mol % is about 20.0 or less.

16. The glass substrate of claim 1, wherein a coefficient of thermal expansion of the glass substrate is about 6.0 ppm/° C. or greater over a temperature range from 25° C. to 300° C.

17. The glass substrate of claim 16, wherein the coefficient of thermal expansion of the glass substrate is from about 6.0 ppm/° C. to about 9.0 ppm/° C. over the temperature range from 25° C. to 300° C.

18. A glass comprising a composition with the following components:
SiO₂ from about 67.0 mol % to about 85.0 mol %;
Al₂O₃ from about 1.0 mol % to about 10.0 mol %;
B₂O₃ from about 2.5 mol % to about 10.0 mol %;
Na₂O from about 5.0 mol % to about 10.0 mol %; and
K₂O from about 0.0 mol % to about 5.0 mol %,
wherein a ratio of monovalent metal oxides in mol % to divalent metal oxides in mol % in the glass composition is from about 1.0 to about 10.0, and
wherein a ratio of a total concentration of the monovalent metal oxides in mol % and the divalent metal oxides in mol % to a concentration of Al₂O₃ in mol % in the glass composition is about 20.0 or less.

19. The glass of claim 18, wherein the composition further comprises:
CaO from about 0.0 mol % to about 7.5 mol %,
MgO from about 0.0 mol % to about 7.5 mol %,
BaO from about 0.0 mol % to about 3.0 mol %,
SrO from about 0.0 mol % to about 3.0 mol %,
TiO₂ from about 0.0 mol % to about 3.0 mol %,
ZnO from about 0.0 mol % to about 3.0 mol %,
Li₂O from about 0.0 mol % to about 0.5 mol %,
ZrO₂ from about 0.0 mol % to about 0.5 mol %,
Cl from about 0.0 mol % to about 0.2 mol %, and
F from about 0.0 mol % to about 0.05 mol %.

20. The glass of claim 18, wherein a coefficient of thermal expansion of the glass is about 6.0 ppm/° C. or greater over a temperature range from 25° C. to 300° C.
